(19) United States
(12) Patent Application Publication
(10) Pub. No.: US 2005/0214668 A1
(43) Pub. Date: Sep. 29, 2005

(54) Toner and developing device using the same

(75) Inventors: Nobuhiro Miyakawa, Nagano (JP); Ken Ikuma, Nagano (JP)

Correspondence Address: HOGAN & HARTSON L.L.P., 500 S. GRAND AVENUE, SUITE 1900, LOS ANGELES, CA, 90071-2611, US

(73) Assignee: SEIKO EPSON CORPORATION

(21) Appl. No.: 11/089,422

(22) Filed: Mar. 23, 2005

(30) Foreign Application Priority Data
Mar. 23, 2004 (JP) P.2004-083951
Mar. 23, 2004 (JP) P.2004-084933

(51) Int. Cl. G03G 9/08

(52) U.S. Cl. 430/108.7; 430/108.3

(57) ABSTRACT

The present invention provides a toner including: a toner mother particle; an amorphous fine particle; a monodisperse spherical silica; and a metal soap, wherein the amorphous particle has the same polarity as the toner mother particle, a volume mean particle size of 0.1 times or less that of the toner mother particle, and a work function larger than that of a cleaning blade of a developing device, wherein an average sphericity of the toner L₀/L₁ is from 0.970 to 0.985, provided that L₁ represents a circumferential length (μm) of a projected image of the toner particle, and L₀ represents a circumferential length (μm) of a true circle having an area equal to that of the projected image of the toner particle.

### FIELD OF THE INVENTION

The present invention relates to a toner for an image forming apparatus of forming an image by developing a latent image formed on a latent image carrier. More specifically, the present invention relates to a toner suitable for an image forming apparatus where toner images are successively formed on an image carrier by using toners of multiple colors and after transferring these images on an intermediate transfer medium by applying a transfer voltage, the image is transferred on a recording material such as paper. The present invention also relates to a developing method using the toner.

### BACKGROUND OF THE INVENTION

In a background art, in same image forming apparatus, an apparatus has a latent image carrier comprising a photoconductor drum or a photoconductor belt, where at the image forming operation, an electrostatic latent image is formed on a photosensitive layer of the photoconductor, the latent image is then developed with a developer of a developing device to form a visible image, and the image is transferred onto a recording material such as paper by using a corona transfer, a transfer roller, a transfer drum or a transfer belt.

Also, in some full-color image forming apparatus, a tandem apparatus, a system in which a plurality of color images are sequentially transferred onto the recording material such as a paper on the transfer belt or transfer drum, one over the other, using a plurality of photoreceptors or a plurality of developing mechanisms, and then fixed, is used. Further, in some image forming apparatus, an apparatus of a 4-cycle intermediate transfer system in which color images are sequentially primarily transferred onto an intermediate transfer medium to perform color superposition, and the primarily transferred images are secondarily transferred together to a transfer material, and an apparatus of a rotary developing system are used.

Other than these, in a background art, some apparatus use a method of removing the untransferred toner remaining on the photoconductor by a cleaning device, and a method of removing the untransferred toner at the development. Also, some image recording apparatus of transferring an image onto a recording material by using an intermediate transfer medium uses a cleaning blade or the like to remove the untransferred toner remaining on the intermediate transfer medium.

The untransferred toner remaining on the photoconductor or intermediate transfer medium after transfer can be decreased by elevating the transfer efficiency. When the amount of the untransferred remaining toner is decreased, the space for a cleaning device is not required and at the same time, the utilization ratio of the toner can be increased. In this meaning, elevation of the toner transfer efficiency is demanded.

As for the technique of elevating the transfer efficiency, in some background art, a spherical toner is used and a spherical inorganic fine particle is added as an external additive, or a difference in speed is provided between the photoconductor and the transfer medium in order to enhance the transfer efficiency. Thereby, a good release of the toner can be attained and therefore, the transfer efficiency is elevated. Also, in the development using some mono-component toner, a toner is formed on the development roller into a thin layer as uniformly as possible by a regulating blade so as to impart sufficient triboelectric charge to the toner, then the toner is negatively charged by the surface of the development roller and the surface at the end part of the regulating blade.

Furthermore, in order to incur no reduction in the image quality and unfailingly prevent the toner cleaning failure, it is proposed to use a spherical toner where a monodisperse spherical silica having a mean particle size of 80 to 300 nm, an organic compound smaller than the monodisperse spherical silica, and an amorphous fine particle having a polarity opposite the charged polarity of the toner and having a volume mean particle size of 0.5 to 10 μm, or instead of this amorphous fine particle, an abrasive fine particle having a polarity opposite the charged polarity of the toner and having a volume mean particle size of 0.3 to 2 μm are added (see, for example, Reference 1).

This proposal has been made with an attempt to join a toner mother particle and an external additive having a large particle size and prevent contamination of the charger or reduction in the image quality due to flying of submicron fine particles.

However, when image formation is continuously performed under the condition of thin layer regulation by using a toner having an excellent transfer efficiency and disengaging the cleaning device from the latent image carrier, the external additive with a large particle size is gradually liberated from the toner surface and since the charged polarity is opposite the polarity of the toner mother particle, this external additive electrostatically adheres to the non-image area of the photoconductor and causes filming on the photoconductor surface.

Furthermore, the external additive which causes filming has the same polarity as that of the power source of applying a voltage to the intermediate transfer medium and therefore, does not move to the intermediate transfer medium, and the amount of filming on the photoconductor tends to increase as the printing proceeds. This gives rise to fogging or reversal transfer toner and at the same time, disadvantageously leads to reduction in the transfer efficiency.

Such a phenomenon is considered to occur because the liberated opposite-polarity external additive with a large particle size or the untransferred toner which is highly negatively charged is fixedly attached to the photoconductor and not transferred to the intermediate transfer belt.
[Reference 1] JP2002-318467 A

An object of the present invention is to provide a toner for a small cleanerless color image forming apparatus, comprising a spherical toner, a monodisperse spherical silica, an inorganic fine particle with a large particle size, a hydrophobic inorganic fine particle with a small diameter, and a metal soap, which causes no reduction in the transfer efficiency even after continuous image formation and requires substantially no cleaning device for the photoconductor when forming toner images comprising toners of multiple colors in a color image forming apparatus where color toner images are formed on an intermediate transfer medium by successively performing development and transfer, en bloc transferred onto a recording material such as paper, and then fixed.

### SUMMARY OF THE INVENTION

The present inventors have made eager investigation to examine the problem. As a result, it has been found that the foregoing objects can be achieved by the following toner and developing device. With this finding, the present invention is accomplished.

The present invention is mainly directed to the following items:
(1) A toner comprising: a toner mother particle; an amorphous fine particle; a monodisperse spherical silica; and a metal soap, wherein the amorphous particle has the same polarity as the toner mother particle, a volume mean particle size of 0.1 times or less that of the toner mother particle, and a work function larger than that of a cleaning blade of a developing device, wherein an average sphericity of the toner mother particle L₀/L₁ is from 0.970 to 0.985, provided that L₁ represents a circumferential length (μm) of a projected image of the particle, and L₀ represents a circumferential length (μm) of a true circle having an area equal to that of the projected image of the particle.

(2) The toner according to item 1, which further comprising first hydrophobic inorganic fine particle having a mean particle size of 7 to 50 nm, wherein the monodisperse spherical silica has a work function of less than 5.1 eV and a particle size of 260 to 320 nm, wherein the amorphous fine particle comprises second hydrophobic inorganic fine particle having the same polarity as the toner mother particle, a volume mean particle size of 0.1 times or less that of the toner mother particle, and a work function larger than that of the monodisperse spherical silica, wherein the metal soap has a work function of 5.25 to 5.7 eV, wherein the toner is a non-magnetic single-component negative-charged toner.

(3) The toner according to item 2, which further comprising a titanium oxide of which surface is hydrophobilized, wherein the second inorganic fine particle has a primary particle size distribution of 200 to 750 nm.

(4) The toner according to item 1, wherein the toner mother particle is obtained by a polymerization method or a dissolution suspension method.

(5) A toner comprising: a toner mother particle; an amorphous fine particle; a monodisperse spherical silica; and a metal soap, wherein the amorphous particle has the same polarity as the toner mother particle, a volume mean particle size of 0.1 times or less that of the toner mother particle, and a work function larger than that of a roll brush of a developing device, wherein an average sphericity of the toner mother particle L₀/L₁ is from 0.970 to 0.995, provided that L₁ represents a circumferential length (μm) of a projected image of the particle, and L₀ represents a circumferential length (μm) of a true circle having an area equal to that of the projected image of the particle.

(6) The toner according to item 5, which further comprising first hydrophobic inorganic fine particle having a mean particle size of 7 to 50 nm, wherein the monodisperse spherical silica has a work function of less than 5.1 eV and a particle size of 260 to 320 nm, wherein the amorphous fine particle comprises second hydrophobic inorganic fine particle having the same polarity as the toner mother particle, a volume mean particle size of 0.1 times or less that of the toner mother particle, and a work function larger than that of the monodisperse spherical silica, wherein the metal soap has a work function of 5.25 to 5.7 eV, wherein the toner is a non-magnetic single-component negative-charged toner.

(7) The toner according to item 6, which further comprising a titanium oxide of which surface is hydrophobilized, wherein the second inorganic fine particle has a primary particle size distribution of 200 to 750 nm.

(8) The toner according to item 5, wherein the toner mother particle is obtained by a polymerization method or a dissolution suspension method.

(9) A developing device comprising the toner according to item 1.

In this way, by specifying sizes and work functions of the fine particles contained in the toner each to a predetermined size, the hydrophobic inorganic fine particle with a large particle size can adhere or fixedly attach to the surface of the toner mother particle. Even if the fine particle is liberated from the surface of the toner mother particle during continuous image formation, the particle liberated can hardly attach to the non-image area on the latent image carrier because it has the same polarity as the toner mother particle. Furthermore, since the particle is negatively charged, the particle can be transferred onto the intermediate transfer medium from the photoconductor in the primary-transfer part and cleaned by a cleaning blade or a roll brush (i.e., fur brush) mounted to the intermediate transfer medium.

In the present invention, a toner contains a toner mother particle, an amorphous fine particle, a monodisperse spherical silica and a metal soap, and in this toner, the amorphous particle has the same polarity as the toner mother particle, a volume mean particle size of 0.1 times or less that of the toner mother particle, and a work function larger than that of a cleaning blade or a roll brush of a developing device, and an average sphericity of the toner mother particle expressed by L₀/L₁ is from 0.970 to 0.985, provided that L₁ represents a circumferential length (μm) of a projected image of the particle, and L₀ represents a circumferential length (μm) of a true circle having an area equal to that of the projected image of the particle. Thereby, the amorphous fine particle can be prevented from leaving the surface of the toner mother particle and even if liberated from the surface of the toner mother particle during continuous image formation, the particle liberated can hardly attach to the non-image area on the latent image carrier because it has the same polarity as the toner mother particle. Furthermore, since the particle is negatively charged, this particle can be transferred onto the intermediate transfer medium from the photoconductor in the primary-transfer part and cleaned by a cleaning blade or a roll brush mounted to the intermediate transfer medium.

### BRIEF DESCRIPTION OF THE DRAWINGS

FIG. 1 is a view showing an example of the non-contact development system in the image forming apparatus using the toner of the present invention.

FIGS. 2A and 2B are views for illustrating examples of the color printer in the tandem system.

FIGS. 3A, 3B and 3C are views for illustrating examples of the color printer in the rotary system.

FIGS. 4A and 4B are views for illustrating a sample measuring cell for measurement of the work function.

FIGS. 5A and 5B are views for illustrating a method for measuring a work function of a sample having other shape.

FIG. 6 is a view for illustrating a apparatus for providing suspended particles.

FIG. 7 is a scanning electron microphotograph of monodisperse spherical silica used in Examples.

FIG. 8 is a scanning electron microphotograph of titanium oxide with a large particle size used in Examples.

### DETAILED DESCRIPTION OF THE INVENTION

The present invention has been accomplished based on the finding that when the fine particles contained in the toner are each made to have a predetermined size and a predetermined work function with respect to the work function of the cleaning blade or a roll brush, even if the fine particle adhering or fixedly attaching to the toner mother particle is liberated from the toner mother particle, the untransferred toner can be unfailingly removed by the cleaning blade or a roll brush mounted to the intermediate transfer medium.

Also, conventional systems of recovering the untransferred toner remaining on the photoconductor in the development part allow paper powders or dusts in air come to be mixed into the development part, therefore, it is difficult to maintain the quality, particularly, color or fine line reproducibility, of a color image over a long period of time and prolong the life of the developing device cartridge.

It has been found that the inorganic external additive with a large particle size is transferred together with the toner mother particle onto the intermediate transfer medium, therefore, the transfer efficiency to a recording material such as paper in the secondary-transfer part is elevated. Also, the inorganic fine particle with a large particle size is an external additive having a work function larger than a cleaning blade or a roll brush for a intermediate transfer medium and since the electric charge or electron electrostatically moves to the periphery including the nip part of the cleaning blade or the neighborhood of the surface of the roll brush, this external additive has electronic property to adhere or fixedly attach to the periphery, so that the intermediate transfer medium can be efficiently cleaned to remove the untransferred toner fine particle remaining on the intermediate transfer medium or paper powders from the transfer sheet.

As a result, a printed matter having high image quality without back staining or transfer failure can be obtained.

In the present invention, it is preferable to add a hydrophobic inorganic fine particle having a mean particle size of 7 to 50 nm.

Also, the monodisperse spherical silica preferably has a work function of less than 5.1 eV and a particle size of 260 to 320 nm.

The amorphous fine particle preferably comprises a hydrophobic inorganic fine particle having the same polarity as the toner mother particle, a volume mean particle size of 0.1 times or less that of the toner mother particle, and a work function larger than that of the monodisperse spherical silica. In the present invention, the amorphous fine particle means a fine particle having a unspecified shape.

The metal soap preferably has a work function of 5.25 to 5.7 eV.

A toner of the present invention is preferably a non-magnetic single-component negative-charged toner.

A toner of the present invention preferably comprises a titanium oxide of which surface is hydrophobilized.

The second inorganic fine particle preferably has a primary particle size distribution of 200 to 750 nm.

The toner mother particle is preferably a toner obtained by a polymerization method or a dissolution suspension method.

The present invention is described below by referring to the drawings.

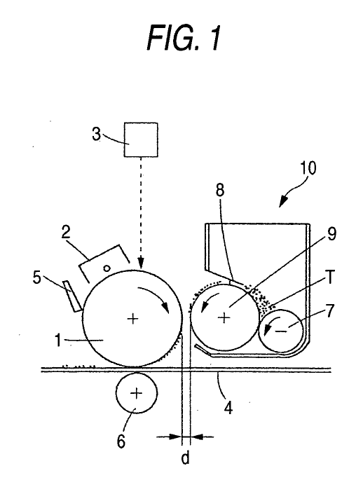

FIG. 1 is a view showing an example of the non-contact development system in the image forming apparatus using the toner of the present invention.

In this system, a development roller 9 faces a photoconductor 1 through a developing gap d. The developing gap is preferably from 100 to 350 μm. As for the developing bias, the DC voltage is preferably from −200 to −500 V and the AC voltage superimposed thereon is preferably from 1.5 to 3.5 kHz under the condition that the P-P voltage is from 1,000 to 1,800 V, though these are not shown. In the non-contact development system, the peripheral velocity of the development roller rotating in the counter-clockwise direction is preferably at a ratio of 1.1 to 2.5, preferably from 1.2 to 2.2, to the peripheral velocity of the organic photoconductor rotating in the clockwise direction.

The development roller 0 rotates in the counter-clockwise direction as shown in FIG. 9 and transports the toner T transported by the toner supply roller 7 to the portion facing the organic photoconductor while keeping the toner T being adsorbed to the surface thereof. When a voltage is applied by superimposing an AC voltage thereon to the portion where the development roller and the organic photoconductor face each other, the toner T vibrates between the development roller surface and the organic photoconductor surface to effect the development. In the present invention, it is considered that since the toner particle can corner into contact with the photoconductor during the vibration of the toner T between the development roller surface and the organic photoconductor surface upon application of AC voltage, the toner particle having a small particle size can be negatively charged and the fogging can be decreased.

The intermediate transfer medium is fed between the photoconductor 1 with a visibilized image and the backup roller 6. At this time, the pressing force on the photo-conductor 1 by the backup roller 6 is preferably from 24.5 to 58.8 mN/m, more preferably from 34.3 to 49 N/m, which is higher than that in the contact development system by about thirty percent.

With a pressing force in this range, the toner particle can be assured of contact with the photoconductor and more negatively charged, and the transfer efficiency can be elevated.

Other items of the non-contact development system are the same as those of the contact development system, and in the image forming apparatus of the present invention, the cleaner blade 5 can be dispensed with.

When the development process shown in FIG. 1 is combined with developing devices for four color toners (developers) of yellow Y, cyan C, magenta M and black K and the photoconductor, an apparatus capable of forming a full color image can be provided.

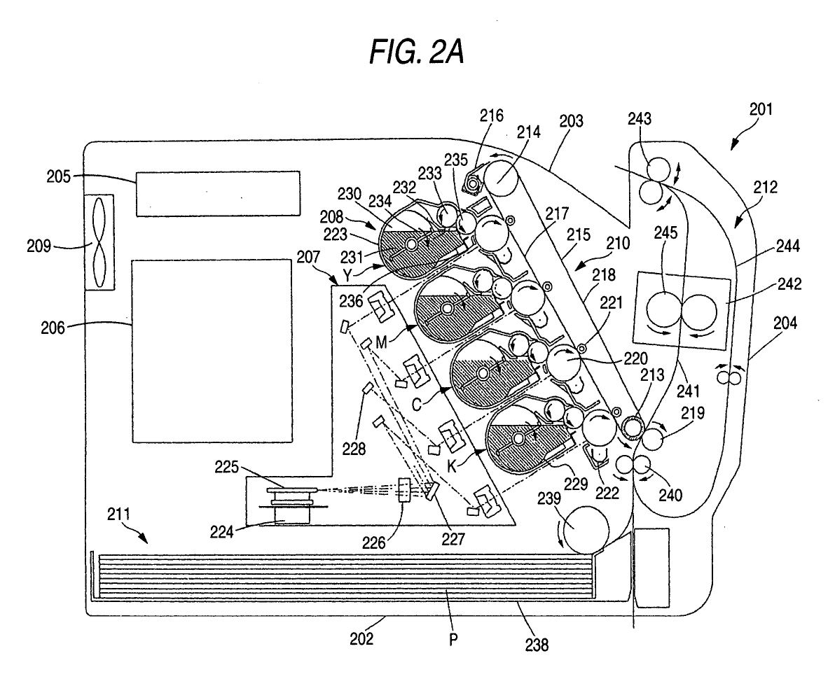

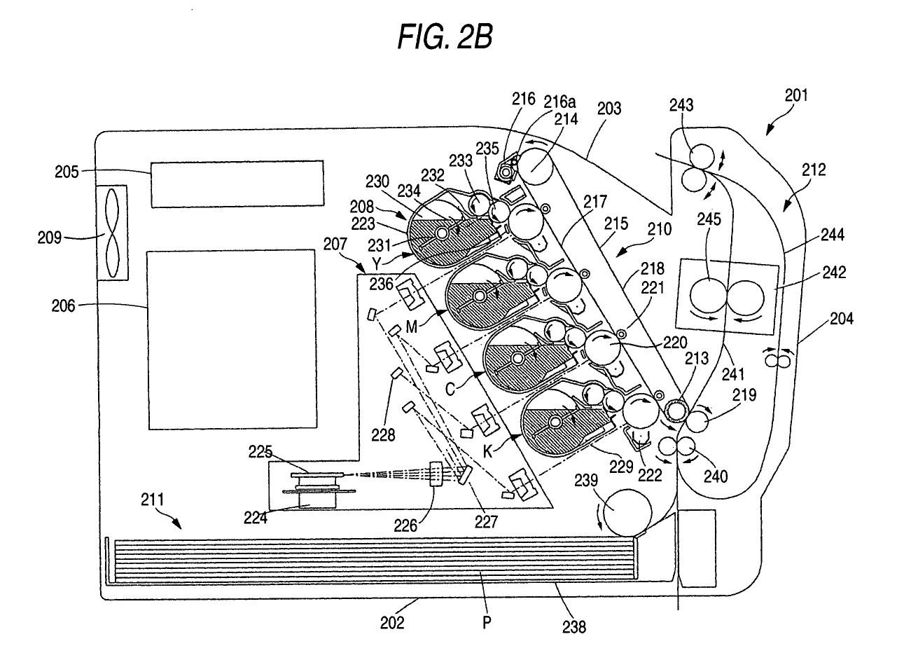

FIGS. 2A and 2B are views for illustrating examples of the color printer in the tandem system.

The image forming apparatus 201 does not have cleaning means for the photoconductor and comprises a housing 202, a paper discharge tray 203 formed at the upper part of the housing 203, and a door body 204 freely openably fixed to the front of the housing 202. In the housing 202, a control unit 205; a power source unit 206, an exposure unit 207, an image forming unit 208, an air discharge fan 209, a transfer unit 210 and a paper feed unit 211 are disposed, and in the door body 204, a paper transport unit 212 is disposed. These units are each attachable to or detachable from the main body and at the maintenance, can be integrally detached for repair or replacement.

The transfer unit 210 comprises a driving roller 213 which is disposed in the lower portion of the housing 202 and driven to rotate by a driving source (not shown), a driven roller 214 which is disposed diagonally above the driving roller 213, and an intermediate transfer belt 215 which is strained only between these two rollers and driven to circulate in the arrow direction shown (counter-clockwise direction). The driven roller 214 and the intermediate transfer belt 215 are disposed to incline toward the left in the figure with respect to the driving roller 213. Accordingly, when the intermediate transfer belt 215 is driven, the belt tense side (the side tensioned by the driving roller 213) 217 takes the lower position and the belt slack side 218 takes the upper position.

The driving roller 213 functions also as a backup roller for a secondary-transfer roller 219 described later. A rubber layer 12a having a thickness of about 3 mm and a volume resistivity of 1×10⁵ Ω·cm or less is formed on the peripheral surface of the driving roller 213 and when the grounded through a metal-made shaft, this roller works out to a conductive path for the secondary-transfer bias supplied through the secondary-transfer roller 219. By providing a rubber layer having high friction and shock absorbing property on the driving roller 12 in this way, an impact generated upon intrusion of a recording material into the secondary-transfer part can be hardly transmitted to the intermediate transfer belt 215, and the deterioration of image quality can be prevented.

In the present invention, the diameter of the driving roller 213 is made to be smaller than the diameter of the driven roller 214, so that a recording paper sheet after secondary transfer can be easily separated by utilizing the elastic force of the recording paper sheet itself.

On the back surface of the intermediate transfer belt 215, primary-transfer members 221 are abutted to oppose respective image carriers 220 of monochromatic image forming units Y, M, C, and K for every each color, which are constituting the image forming unit 208 described later. A transfer bias is applied to each primary-transfer member 221.

The image forming unit 208 comprises monochromatic image forming units Y (for yellow), M (for magenta), C (for cyan) and K (for black) for forming multiple (in this embodiment, four) images differing in the color. The monochromatic image forming units Y, M, C and K each has an image carrier 220 comprising a photoconductor having formed thereon an organic photosensitive layer and an inorganic photosensitive layer and in the periphery of the image carrier 220, charging means 222 comprising a corona charger or a charging roller and developing means 223 are disposed.

The monochromatic image forming units Y, M, C and K are disposed such that respective image carriers 220 abut against the belt tense side 217 of the intermediate transfer belt 215. In turn, the monochromatic image forming units Y, M, C and K are disposed in the direction inclining toward the left in the figure with respect to the driving roller 213. The image carriers 220 each is driven to rotate in the direction opposite the intermediate transfer belt 215 as shown by the arrow.

The exposure unit 207 is disposed in the obliquely lower portion from the image forming unit 208 and comprises in the inside thereof a polygon mirror motor 224, a polygon mirror 225, an f-θ lens 226, a reflection mirror 227 and a turn-back mirror 228. Image signals corresponding to respective colors are formed and modulated based on the common data clock frequency, ejected from the polygon mirror 225 and after passing through those f-θ lens 226, reflection mirror 227 and burn-back mirror 228, irradiated on respective image carriers 220 of the monochromatic image forming units Y, M, C and K, thereby forming latent images. The optical path lengths to respective image carriers 220 of the monochromatic image forming units Y, M, C and K are made substantially the same by the operation of the turn-back mirror 228.

The developing means 223 is described below by taking the monochromatic image forming unit Y as a representative. In this embodiment, the monochromatic image forming units Y, M, C and K are disposed in the direction inclining to the left in the figure and therefore, the toner-housing container 229 is disposed to incline obliquely downward.

That is, the developing means 223 comprises a toner-housing container 229 for housing the toner, a toner storage part 230 (indicated by hatching) formed in the toner-housing container 229, a toner stirring member 231 disposed inside the toner storage part 230, a partitioning member 232 defined and formed in the upper portion of the toner storage part 230, a toner supply roller 233 disposed above the partitioning member 232, a charging blade 234 provided on the partitioning member 232 to abut against the toner supply roller 233, a development roller 235 disposed in proximity to the toner supply roller 233 and the image carrier 220, and a regulating blade 236 abutted against the development roller 235.

The development roller 235 and the toner supply roller 233 are rotated, as shown by the arrows, in the direction opposite the rotation direction of the image carrier 220. On the other hand, the stirring member 231 is driven to rotate in the direction opposite to the rotation direction of the supply roller 233. The toner stirred and scooped up by the stirring member 231 in the toner storage part 230 is supplied to the toner supply roller 233 along the upper surface of the partitioning member 232. The toner supplied causes friction with the charging blade 234 made of a flexible material and this creates adhesive forces to the rough surface of the supply roller 233, that is, a mechanical adhesive force and an adhesive force by triboelectric charging. By the effect of these adhesive forces, the toner is supplied to the surface of the development roller 235.

The toner supplied to the development roller 235 is regulated into a thin layer having a predetermined thickness by the regulating blade 236. The toner layer as a thin layer is transported to the image carrier 220 and develops a latent image on the image carrier 220 in the development region where the development roller 245 and the image carrier 220 come into proximity.

The paper feed unit 211 comprises a paper feed cassette 238 where a plurality of recording material P sheets are stacked and held, and a pickup roller 239 for feeding the recording material P sheets from the paper feed cassette 238 one by one at the image formation.

The paper transport unit 212 comprises a pair of gate rollers 240 (one roller is provided on the housing 202 side) for regulating the timing of feeding a recording material P sheet to the secondary-transfer part, a secondary-transfer roller 219 which is secondary-transfer means and contacted under pressure with the driving roller 213 and intermediate transfer belt 215, a main recording material transport path 241, fixing means 242, a pair of paper discharge rollers 243, and a transport path 244 for double-sided print. After the completion of transfer to the recording material, the untransferred toner remaining on the image carrier 220 is removed by cleaning means 216. In FIG. 2B, the cleaning means 216 has a roll brush 216a, which comes in contact with the intermediate transfer belt 215.

The fixing means 242 comprises a pair of freely rotatable fixing rollers 245 with at least one having a built-in heating element such as halogen heater, and pressing means for pressing at least one of the paired fixing rollers against the other roller so that the secondary image secondarily transferred onto the sheet material can be fixed on the recording material P. The secondary image secondarily transferred onto the recording material is fixed on the recording material at a predetermined temperature in the nip part formed by the paired fixing rollers 245.

In the present invention, the intermediate transfer belt 215 is disposed in the direction inclining to the left in the figure with respect to the driving roller 213 and therefore, a wide space is created on the right side. The fixing means 242 can be disposed in this space and by this configuration, not only reduction in the size of the image forming apparatus can be realized but also the heat generated in the fixing means 242 can be prevented from adversely affecting the exposure unit 207, intermediate transfer belt 215 and respective monochromatic image forming units Y, M, C and K, which are located on the left side.

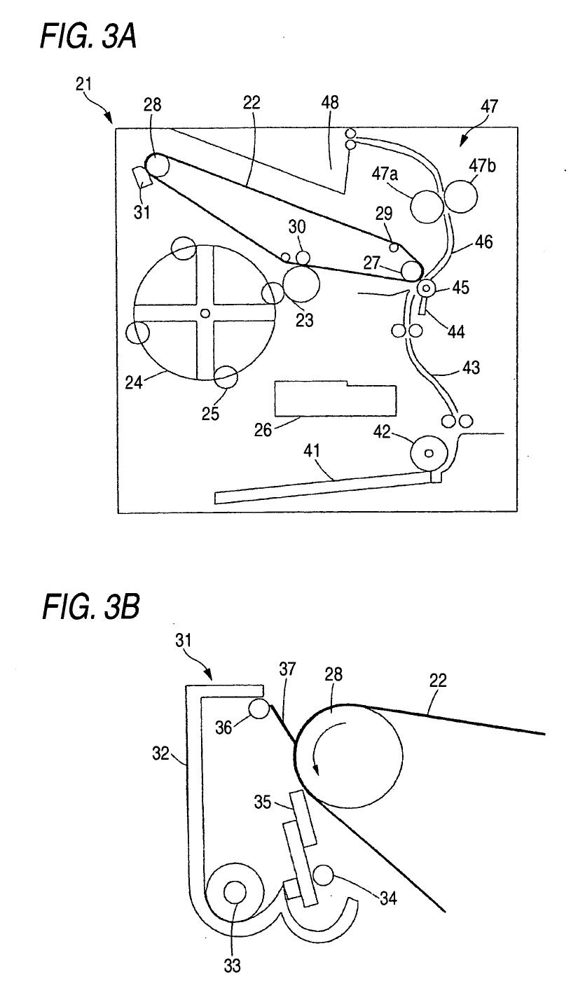

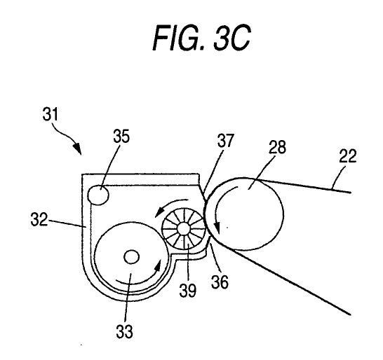

FIGS. 3A, 3B and 3C are views for illustrating examples of the color printer in the rotary system.

FIG. 3A is a view for explaining the entire constitution of the color printer, and FIGS. 3B and 3C are views for explaining the cleaning means.

The color printer shown in FIGS. 3A to 3C is characterized by having no cleaning blade for the photoconductor.

In the image forming apparatus 21, the photoconductor 23 is evenly charged by a charger (not shown), and an electrostatic latent image is formed by image exposure from the exposing device 26. The rotary-type developing device 24 of toner-developing an electrostatic latent image has developing units for four colors of Y, M, C and K. The development roller 25 of each unit reaches the photoconductor position by the effect of the intermittent rotation of the rotary-type developing device and faces the photoconductor 23 at this position to perform the toner development. An intermediate transfer medium 22 strained by a driving roller 27, a driven roller 28, a tension roller 29, a primary-transfer roller 30 and the like abuts against the photoconductor 23 at the position of the primary roller 30, and the primary transfer is performed by transferring the toner image formed on the photoconductor onto the intermediate medium 22. In this way, four colors are superposed on the image transfer medium.

A secondary-transfer roller 45 caused to retreat from or abut against the intermediate transfer medium 22 by the retreating/abutting mechanism 44 is provided at the position facing the driving roller 27 which serves also as a secondary-transfer backup roller, and at this position, toner images of four colors on the intermediate medium are en bloc secondarily transferred, thereby transferring an image. That is, a paper sheet delivered by the paper delivery roller 42 from the paper tray 41 is transported to the position of the secondary transfer roller 45 through the paper transport path 43. The secondary-transfer roller 45 is retreating from the intermediate transfer medium during the primary transfer of superposing colors on the intermediate transfer medium, but at the secondary transfer, caused to abut against the intermediate transfer medium 22 and when a transfer bias is applied, the toner images of four colors are en bloc transferred onto the paper sheet from the intermediate transfer medium. The paper sheet after the secondary transfer is introduced into a fixing device 47 comprising a heating roller 47a and a pressing roller 47b through a paper guide 46 and discharged into a paper discharge tray 48 on the top of the apparatus.

The cleaning means 31 which retreat from or abuts against the intermediate transfer medium 22 by using the driven roller 28 as the backup roller retreats from or abuts against the intermediate transfer medium 22 by the retreating/abutting mechanism. This cleaning means abuts after the secondary transfer to remove the residual toner on the intermediate transfer medium. A cleaning blade, a roll brush, a roller or a sheet may be used as the cleaning member.

FIGS. 3B and 3C are views for explaining the cleaning means.

In FIG. 3B, the cleaning means 31 is provided in the vicinity of the driven roller 28 to face the intermediate transfer medium 22 and in its cleaner case 32, a spiral rotor 33 comprising a spiral member such as metal spring is disposed. Furthermore, a cleaning blade 35 which can be made to retreat from or abut against the intermediate medium 22 by a blade fulcrum shaft 34, and an upper sheet 37 which can be made to retreat from or abut against the intermediate medium 22 by an upper blade fulcrum shaft 34, are provided each in the state of being fixed in the cleaner case 32.

In FIG. 3C, the cleaning means 31 is provided in the vicinity of the driven roller 28 to face the intermediate transfer medium 22 and in its cleaner case 32, a spiral rotor 33 comprising a spiral member such as metal spring is disposed and abutting/retreating means 35 is fixed to hold the cleaner case 32 and abuttably/retreatably arrange the cleaning means 31 at the development. Furthermore, a lower seal 36 and an upper seal 37 are provided in the cleaning blade case 32 to prevent spilling of the toner from between the cleaning case and the intermediate transfer medium 22.

In FIGS. 3B and 3C, the toner remaining on the intermediate transfer medium 22 after secondary transfer is scraped off by the cleaning blade 35 or the roll brush 39 rotating to a direction opposite to the intermediate transfer medium, housed in the cleaner case 32, transported by the spiral rotor 33, and transferred to a waste toner tank (not shown) from the cleaner case 32. However, the toner in the cleaner case 32 is difficult to completely remove and if the apparatus is vigorously vibrated due to transportation or the like in the state of the waste toner remaining, the toner remaining in the cleaner flies and spreads inside the apparatus. Therefore, it is preferred to provide a hole for cleaning in the cleaner case and suck the residual toner through the hole.

The measurement cell used for measuring the work function of the toner and external additives is described below.

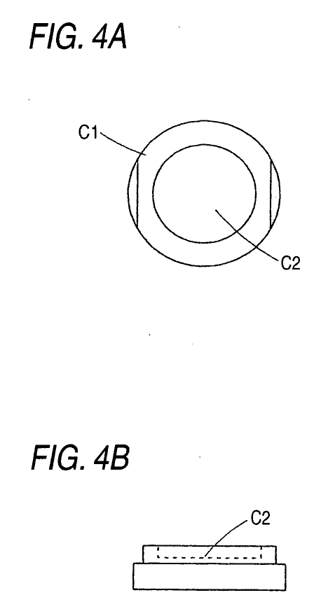

FIGS. 4A and 4B are views for explaining the sample measurement cell for the measurement of work function.

FIG. 4A is a plan view and FIG. 4B is a side view. The sample measurement cell C1 is a stainless steel-made disk with a diameter of 13 mm and a height of 5 mm and has a shape such that a toner-housing recess part C2 having a diameter of 10 mm and a depth of 1 mm is provided at the center of the disk. The toner is charged into the recess part of the cell by using a weighting spoon without ramming it and after leveling the surface thereof by a knife edge, subjected to the measurement in this state.

The measurement cell filled with the toner is fixed to a sample stage at a predetermined position and then, the measurement is performed by setting the conditions such that the irradiation light intensity is 500 nW, the irradiation area is a 4-mm square, and the energy scanning range is from 4.2 to 6.2 eV.

Also, the normalized electron yield at the time of measuring the work function of the toner is 8 or more with a measurement light intensity of 500 nW.

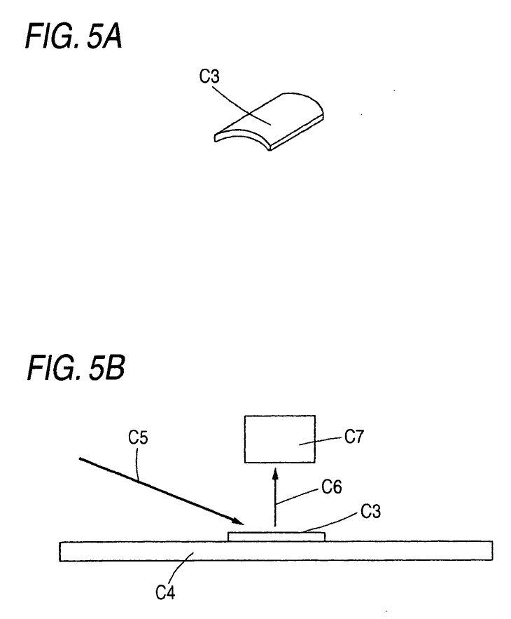

FIGS. 5A and 5B are views for explaining the method for measuring a work function of a sample having another shape.

In the case where the sample is a cylindrical member such as intermediate transfer medium and latent image carrier, the cylindrical member is cut into a width of 1 to 1.5 cm and further cut in the lateral direction along ridge lines to obtain a specimen C3 for measurement having a shape shown in FIG. 5A and then, as shown in FIG. 5B, the specimen is fixed to a predetermined position on the sample stage C4 such that the surface to be irradiated runs in parallel to the irradiation direction of the measurement light C5, whereby the photoelectron C6 emitted can be efficiently detected by the detector C7, that is, photomultiplier.

The toner of the present invention may be a toner obtained by either a grinding method or a polymerization method, but a toner obtained by a polymerization method is preferred because of its good sphericity.

As for the toner obtained by the grinding method, a release agent, a charge control agent and the like are added to a resin binder containing at least a pigment and uniformly mixed by a Henschel mixer or the like, and the resulting mixture is melt-kneaded by a twin-screw extruder, cooled, classified through rough grinding-fine grinding, and attached with external particles to prepare a toner particle.

As for the binder resin, a synthetic resin used as a resin for toners may be used. Examples thereof include styrene-based resins which are homopolymers or copolymers containing styrene or a styrene substitution product, such as polystyrene, poly-α-methylstyrene, chloropolystyrene, styrene-chlorostyrene copolymer, styrene-propylene copolymer, styrene-butadiene copolymer, styrene-vinyl chloride copolymer, styrene-vinyl acetate copolymer, styrene-maleic acid copolymer, styrene-acrylate copolymer, styrene-methacrylate copolymer, styrene-acrylate-methacrylate copolymer, styrene-α-methyl chloracrylate copolymer, styrene-acrylonitrile-acrylate copolymer and styrene-vinyl methyl ether copolymer, polyester resins, epoxy resins, urethane-modified epoxy resins, silicone-modified epoxy resin, vinyl chloride resins, rosin-modified maleic acid resins, phenyl resins, polyethylene, polypropylene, ionomer resins, polyurethane resins, silicone resins, ketone resins, ethylene-ethyl acrylate copolymers, xylene resins, polyvinylbutyral resins, terpene resins, phenolic resins and aliphatic or alicyclic hydrocarbon resins. These resins may be used individually or in combination.

Among these, preferred in the present invention are styrene-acrylate-based resins, styrene-methacrylate-based resins and polyester resins. The binder resin preferably has a glass transition temperature of 50 to 75° C. and a flow softening temperature of 100 to 150° C.

As for the coloring agent, a coloring agent for toners may be used. Examples thereof include dyes and pigments such as carbon black, lamp black, magnetite, titanium black, chrome yellow, ultramarine blue, aniline blue, phthalocyanine blue, phthalocyanine green, Hansa Yellow G, rhodamine 6G, chalco oil blue, quinacridone, benzidine yellow, Rose Bengal, malachite green lake, quinoline yellow, C.I. Pigment Red 48:1, C.I. Pigment Red 122, C.I. Pigment Red 57:1, C.I. Pigment Red 122, C.I. Pigment Red 184, C.I. Pigment Yellow 12, C.I. Pigment Yellow 17, C.I. Pigment Yellow 97, C.I. Pigment Yellow 180, C.I. Solvent Yellow 162, C.I. Pigment Blue 5:1 and C.I. Pigment Blue 15:3. These dyes and pigments can be used individually or in combination.

As for the release agent, a release agent for toners may be used. Examples thereof include paraffin wax, micro-wax, microcrystalline wax, candelilla wax, carnauba wax, rice wax, montan wax, polyethylene wax, polypropylene wax, oxygen convertible polyethylene wax and oxygen convertible polypropylene wax. Among these, preferred are polyethylene wax, polypropylene wax, carnauba wax and ester wax.

As for the charge control agent, a charge control agent for toners may be used. Examples thereof include Oil Black, Oil Black BY, Bontron S-22 and S-34 (produced by Orient Chemical Industries, Ltd.), salicylic acid metal complexes E-81 and E-84 (produced by Orient Chemical Industries, Ltd.), thioindigo-type pigments, sulfonylamine derivatives of copper phthalocyanine, Spilon Black TRH (produced by Hodogaya Chemical Co., Ltd.), calix arene-based compounds, organic boron compounds, fluorine-containing quaternary ammonium salt-based compounds, monoazo metal complexes, aromatic hydroxyl carboxylic acid-based metal complexes, aromatic dicarboxylic acid-based metal complexes and polysaccharides. Among these, colorless or white agents are preferred for color toners.

As for the compositional ratio in the toner obtained by the grinding method, the coloring agent is from 0.5 to 15 parts by weight, preferably from 1 to 10 parts by weight, the release agent is from 1 to 10 parts by weight, preferably from 2.5 to 8 parts by weight, and the charge control agent is from 0.1 to 7 parts by weight, preferably from 0.5 to 5 parts by weight, per 100 parts by weight of the binder resin.

In order to improve the transfer efficiency, the toner obtained by the grinding method for use in the present invention is preferably spheroidized. For this purpose, when an apparatus capable of grinding the toner into a relatively round shape, for example, a turbo mill (manufactured by Turbo Kogyo Co., Ltd.) well known as a mechanical grinder is used, the sphericity can be elevated up to 0.93. Also, when the ground toner is treated in a hot-air spheroidizing apparatus (manufactured by Nippon Pneumatic Mfg. Co., Ltd.), the sphericity can be elevated up to 1.00.

In the present invention, the mean particle size and sphericity of the toner particle are the values measured by a particle image analyzer (FPIA2100, manufactured by Sysmex Corporation).

The toner obtained by the polymerization method includes toners obtained by a suspension polymerization method, an emulsion polymerization method, a dispersion polymerization method and the like. In the suspension polymerization, a monomer composition prepared by dissolving or dispersing a composite material comprising a polymerizable monomer, a coloring pigment and a release agent and, if desired, further containing a dye, a polymerization initiator, a crosslinking agent, a charge control agent and other additives is added to an aqueous phase containing a suspension stabilizer (e.g., water-soluble polymer, sparingly water-soluble inorganic material) with stirring, then granulated and polymerized, whereby colored polymer toner particles having a desired particle size can be formed.

In the emulsion polymerization, a monomer and a release agent and further, if desired, a polymerization initiator, an emulsifier (surfactant) and the like are dispersed in water and polymerized and during the coagulation process, a coloring agent, a charge control agent and a coagulant (electrolyte) are added, whereby colored toner particles having a desired particle size can be formed.

Out of the materials used for the production of a toner by the polymerization method, as for the coloring agent, release agent and charge control agent, the same materials described above for the toner obtained by the grinding method can be used.

As for the polymerizable monomer component, a vinyl-based monomer may be used. Examples thereof include styrene, o-methylstyrene, m-methylstyrene, p-methylstyrene, α-methylstyrene, p-methoxystyrene, p-ethylstyrene, vinyltoluene, 2,4-dimethylstyrene, p-n-butylstyrene, p-phenylstyrene, p-chlorostyrene, divinylbenzene, methyl acrylate, ethyl acrylate, propyl acrylate, n-butyl acrylate, isobutyl acrylate, n-octyl acrylate, dodecyl acrylate, hydroxyethyl acrylate, 2-ethylhexyl acrylate, phenyl acrylate, stearyl acrylate, 2-chloroethyl acrylate, methyl methacrylate, ethyl methacrylate, propyl methacrylate, n-butyl methacrylate, isobutyl methacrylate, n-octyl methacrylate, dodecyl methacrylate, hydroxyethyl methacrylate, 2-ethylhexyl methacrylate, stearyl methacrylate, phenyl methacrylate, acrylic acid, methacrylic acid, maleic acid, fumaric acid, cinnamic acid, ethylene glycol, propylene glycol, maleic anhydride, phthalic anhydride, ethylene, propylene, butylene, isobutylene, vinyl chloride, vinylidene chloride, vinyl bromide, vinyl fluoride, vinyl acetate, vinyl propylenate, acrylonitrile, methacrylonitrile, vinyl methyl ether, vinyl ethyl ether, vinyl ketone, vinyl hexyl ketone and vinyl naphthalene. Also, a fluorine-containing monomer such as 2,2,2-trifluoroethyl acrylate, 2,2,3,3-tetrafluoropropyl acrylate, vinylidene fluoride, ethylene trifluoride, ethylene tetrafluoride and trifluoropropylene may be used because the fluorine atom is effective for the negative charge control.

Examples of the emulsifier (surfactant) include sodium dodecylbenzenesulfonate, sodium tetradecylsulfate, sodium pentadecylsulfate, sodium octylsulfate, sodium oleate, sodium laurate, potassium stearate, calcium oleate, dodecylammonium chloride, dodecylammonium bromide, dodecyltrimethylammonium bromide, dodecylpyridinium chloride, hexadecyltrimethylammonium bromide, dodecyl-polyoxyethylene ether, hexadecylpolyoxyethylene ether, laurylpolyoxyethylene ether and sorbitan monooleate polyoxyethylene ether.

Examples of the polymerization initiator include potassium persulfate, sodium persulfate, ammonium persulfate, hydrogen peroxide, 4,4′-azobiscyanovaleric acid, tert-butyl hydroperoxide, benzoyl peroxide and 2,2′-azobis-isobutyronitrile.

Examples of the coagulant (electrolyte) include sodium chloride, potassium chloride, lithium chloride, magnesium chloride, calcium chloride, sodium sulfate, potassium sulfate, lithium chloride, magnesium sulfate, calcium sulfate, zinc sulfate, aluminum sulfate and iron sulfate.

As for the method of adjusting the sphericity of the toner obtained by the polymerization method, in the emulsion polymerization method, the sphericity can be freely changed by controlling the temperature and time in the coagulating process of secondary particles, and the sphericity is from 0.94 to 1.00. In the suspension polymerization method, a perfect spherical toner can be obtained and therefore, the sphericity is from 0.98 to 1.00. Also, when the toner is heated and deformed at a temperature higher than the Tg temperature of the toner so as to adjust the sphericity, the sphericity can be freely adjusted to a range from 0.94 to 0.98.

The number mean particle size of the toner is preferably 9 μm or less, more preferably from 8 to 4.5 μm. If the toner is larger than 9 μm, even when a latent image with high resolution of 1,200 dpi or more is formed, the reproducibility of the resolution decreases as compared with the toner having a small particle size, whereas if the number mean particle size is less than 4.5 μm, the masking property by the toner decreases and at the same time, the amount of external additives used increases so as to elevate the fluidity, as a result, the fixing performance disadvantageously tends to deteriorate.

The external additives are described below. The toner particle of the present invention contains, as external additives, a silica particle and a surface modified silica particle obtained by modifying the surface of silica with an oxide or hydroxide of at least one metal selected from titanium, tin, zirconium and aluminum. The surface modified silica particle is contained at a ratio of 1.5 times or less in terms of the weight ratio to the silica particle.

As for other external additives, various inorganic or organic fluidity improving agents for toner can be used. Examples of the fluidity improving agent which can be used include each fine particle of positively chargeable silica, titanium dioxide, alumina, zinc oxide, magnesium fluoride, silicon carbide, boron carbide, titanium carbide, zirconium carbide, boron nitride, titanium nitride, zirconium nitride, zirconium oxide, magnetite, molybdenum disulfide, aluminum stearate, magnesium stearate, zinc stearate, calcium stearate, metal salt of titanic acid (e.g., strontium titanate) and metal salt of silicon. Such a fine particle is preferably used after hydrophobing it with a silane coupling agent, a titanium coupling agent, a higher fatty acid, a silicone oil or the like. Other examples of the resin fine particle include acrylic resin, styrene resin, and fluororesin. These fluidity improving agents can be used individually or in combination, and the amount of the fluidity improving agent used is preferably from 0.1 to 5 parts by weight, more preferably from 0.5 to 4.0 parts by weight, per 100 parts by weight of the toner.

The silica particle may be produced by either a dry process from a halide or the like of silicon, or a wet process of precipitating it in a liquid from a silicon compound.

The silica particle preferably has a mean primary particle size of 7 to 40 nm, more preferably from 10 to 30 nm. If the mean primary particle size is less than 7 nm, the silica particle is readily buried in the toner mother particle and the toner tends to be negatively overcharged, whereas if it exceeds 40 nm, the effect of imparting fluidity to the toner mother particle decreases and the toner is difficult to uniformly charge with a negative charge, as a result, the amount of the toner inversely charged with a positive charge tends to increase.

The silica particle for use in the present invention is preferably a mixture of silica particles differing in the number mean particle size distribution. By containing an external additive with a large particle size, the external particle can be prevented from being buried in the toner particle, and by virtue of the small-diameter silica particle, preferred fluidity can be obtained.

More specifically, in the silica particles used in combination, the number mean primary particle size of one silica is preferably from 5 to 20 nm, more preferably from 7 to 16 nm, and the number mean primary particle size of another silica is preferably from 30 to 50 nm, more preferably from 30 to 40 nm.

In the present invention, the particle size of the external additive is measured by observing it on an electron microscope image, and the number mean particle size is employed as the number particle size.

The silica particle used as an external additive in the present invention is preferably used after hydrophobing it with a silane coupling agent, a titanium coupling agent, a higher fatty acid, a silicone oil or the like. Examples thereof include dimethyldichlorosilane, octyltrimethoxy-silane, hexamethyldisilazane, silicone oil, octyltrichloro-silane, decyltrichlorosilane, nonyltrichlorosilane, (4-iso-propylphenyl)trichlorosilane, (4-tert-butylphenyl)-trichlorosilane, dipentyldichlorosilane, dihexyldichloro-silane, dioctyldichlorosilane, dinonyldichlorosilane, didecyldichlorosilane, didodecyldichlorosilane, (4-tert-butylphenyl)octyldichlorosilane, didecenyldichlorosilane, dinonenyldichlorosilane, di-2-ethylhexyldichlorosilane, di-3,3-dimethylpentyldichlorosilane, trihexylchlorosilane, trioctylchlorosilane, tridecylchlorosilane, dioctylmethyl-chlorosilane, octyldimethylchlorosilane and (4-iso-propylphenyl)diethylchlorosilane.

Also, in combination with the silica particle, silica of which surface is modified with a metal compound is preferably used in a predetermined amount based on the silica particle. The surface modified silica is obtained by covering a particulate silica having a specific surface area of 50 to 400 m²/g, with a hydroxide or oxide of at least one member selected from titanium, zinc, zirconium and aluminum.

As for the amount blended thereof, a particulate silica slurry covered with from 1 to 30 parts by weight of the above-described hydroxide or oxide per 100 parts by weight of the particulate silica is prepared, then covered with an alkoxysilane in an amount of 3 to 50 parts by weight based on the solid content in the slurry, neutralized with an alkali, filtered, washed, dried and ground, whereby the surface modified silica can be obtained. The silica fine particle used for the surface modified silica may be either a particle produced by a wet process or a particle produced by a vapor phase process.

For the surface modification of the particulate silica, an aqueous solution containing at least one member of titanium, tin, zirconium and aluminum can also be used. Examples thereof include titanium sulfate, titanium tetrachloride, tin chloride, stannous sulfate, zirconium oxychloride, zirconium sulfate, zirconium nitrate, aluminum sulfate and sodium aluminate.

The surface modification of the particulate silica with such a metal oxide or hydroxide can be performed by treating the particulate silica slurry with an aqueous solution of the above-described metal compound. The treating temperature is preferably from 20 to 90° C.

Thereafter, the particulate silica is covered with an alkoxysilane and thereby hydrophobed. The hydrophobing treatment can be realized by adjusting the slurry to a pH of 2 to 6, preferably a pH of 3 to 6, then adding from 30 to 50 parts by weight of at least one alkoxysilane per 100 parts by weight of the silica fine particle, adjusting the slurry temperature to 20 to 100° C., preferably from 30 to 70° C., and performing hydrolysis and condensation reactions.

After the addition of alkoxysilane, the slurry is preferably stirred and adjusted to a pH of 4 to 9, more preferably a pH of 5 to 7, so as to accelerate the condensation reaction. The pH can be adjusted by using sodium hydroxide, potassium hydroxide, sodium carbonate, aqueous ammonia, ammonia gas or the like. By performing such treatments, uniformly hydrophobed stable fine particles are obtained.

Subsequently, the slurry is filtered, washed with water and dried, whereby surface modified silica fine particles can be obtained.

The drying temperature is from 100 to 190° C., preferably from 110 to 170° C. If the drying temperature is less than 100° C., the drying efficiency is bad and the degree of hydrophobation disadvantageously decreases, whereas if it exceeds 190° C., thermal decomposition of the hydrocarbon group occurs to cause discoloration and decrease in the degree of hydrophobation and this is not preferred.

The hydrophobation treatment can also be performed by adding an alkoxysilane to the surface modified silica particle and effecting covering with use of a Henschel mixer or the like.

In the present invention, the amount of such an external additive is preferably from 0.05 to 2 parts by weight per 100 parts by weight of the toner mother particle.

If the amount added is less than 0.05 parts by weight, an effect of imparting fluidity and preventing overcharge cannot be obtained, whereas if it exceeds 2 parts by weight, the negative charge amount decreases and at the same time, the amount of toner charged with a positive charge which is reversed polarity is increased and this gives rise to increase in the fogging or amount of reversal transfer toner.

### EXAMPLES

The present invention is now illustrated in greater detail with reference to Examples and Comparative Examples, but it should be understood that the present invention is not to be construed as being limited thereto.

### Example 1

### Production of Toner by Polymerization Method

### Production of Toner Mother Particle 1

A monomer mixture comprising 80 parts by weight of styrene monomer, 20 parts by weight of butyl acrylate and 5 parts by weight of acrylic acid was added to an aqueous solution mixture containing 105 parts by weight of water, 1 part by weight of nonionic emulsifier (Emulgen 950, produced by Dai-ichi Kogyo Seiyaku Co., Ltd.), 1.5 parts by weight of anionic emulsifier (Neogen R, produced by Dai-ichi Kogyo Seiyaku Co., Ltd.) and 0.55 parts by weight of potassium persulfate, and polymerized at 70° C. for 8 hours with stirring in a nitrogen stream. By cooling after polymerization reaction, a milky white resin emulsion having a particle size of 0.25 μm was obtained.

Thereafter, 200 parts by weight of the resin emulsion obtained above, 20 parts by weight of polyethylene wax emulsion (Permarin PN, produced by Sanyo Chemical Industries, Ltd.) and 7 parts by weight of phthalocyanine blue were dispersed in water containing 0.2 parts by weight of sodium dodecylbenzenesulfonate as a surfactant and after adjusting the pH to 5.5 by adding diethylamine, 0.3 parts by weight of aluminum sulfate as an electrolyte was added with stirring. Subsequently, the mixture was dispersed with high-speed stirring by an emulsification-dispersing apparatus (TK Homomixer, manufactured by Tokushu Kika Kogyo Co., Ltd.).

Furthermore, 40 parts by weight of styrene monomer, 10 parts by weight of butyl acrylate and 5 parts by weight of zinc salicylate were added together with 40 parts by weight of water and after heating to 90° C. with stirring in a nitrogen stream, hydrogen peroxide was added to effect the polymerization for 5 hours, thereby growing the particles. After the stopping of polymerization, the temperature was elevated to 95° C. while adjusting the pH to 5 or more and held for 5 hours so as to enhance the bonding strength between particles. Thereafter, the particles obtained were washed with water and vacuum-dried at 45° C. for 10 hours.

The particle size of the toner obtained was 7.6 μm in terms of the mean particle size on the volume basis and 6.8 μm in terms of the average particle size on the number basis, and the sphericity was 0.98. This toner is designated as Toner Mother Particle 1.

In this Example, the sphericity was measured by using a flow-type particle image analyzer (FPIA2100, manufactured by Sysmex Corporation) and expressed by the following mathematical formula (I):
R=L₀/L₁ (I)
wherein
L₁ is the circumferential length (μm) of the projected image of a particle to be measured, and L₀ is the circumferential length (μm) L₀ of a true circle having an area equal to that of the projected image of the particle to be measured.

The work function of the toner obtained was measured by using a surface analyzer (Model AC-2, manufactured by Riken Keiki Co., Ltd.) with an irradiation light intensity of 500 nW and found to be 5.57 eV.

### Production of Toner Mother Particle 2

A magenta toner was obtained in the same manner as in Production of Toner Mother Particle 1 except for using quinacridone in place of phthalocyanine blue and holding 90° C. as-is without elevating the temperature to 95° C., so as to enhance the aggregation of secondary particles and the bonding strength for film formation.

The magenta toner obtained was a toner having a mean particle size of 7.9 μm on the volume basis, a mean particle size of 7.0 μm on the number bases and a sphericity of 0.976. This toner was designated as Toner Mother Particle 2. The work function thereof was measured in the same manner and found to be 5.64 eV.

### Production Example of Toner Mother Particles 3 and 4

A yellow toner and a black toner were obtained by performing the polymerization in the same manner as in Production Example of Toner Mother Particle 1 except for using Pigment Yellow 180 and carbon black, respectively, in place of phthalocyanine blue in Production of Toner Mother Particle 1.

The yellow toner mother particle obtained was a toner having a mean particle size of 7.7 μm on the volume basis, a mean particle size of 6.9 μm on the number basis, and a sphericity of 0.973. This yellow toner was designated as Toner Mother particle 3. The work function thereof was measured in the same manner and found to be 5.59 eV.

The black toner mother particle obtained was a toner having a mean particle size of 7.8 μm on the volume basis, a mean particle size of 7.0 μm on the number basis, and a sphericity of 0.974. This black toner was designated as Toner Mother particle 4. The work function thereof was measured in the same manner and found to be 5.52 eV.

### Production of Toner by Dissolution and Suspension Method

### Production of Toner Mother Particle 5

100 Parts by weight of a 50:50 (by weight) mixture (Himer ES-803, produced by Sanyo Chemical Industries, Ltd.) of a polycondensate polyester (obtained from an aromatic dicarboxylic acid and an alkylene etherified bisphenol A) and a partially crosslinked product of the polycondensate polyester with a polyvalent metal compound, 5 parts by weight of Pigment Blue 15:1 as a cyan pigment, 3 parts by weight of carnauba wax having a melting point of 80 to 86° C. as a release agent, and 4 parts by weight of a metal complex of salicylic acid (E-81, produced by Orient Chemical Industries, Ltd.) as a charge control agent were uniformly mixed by a Henschel mixer, kneaded by a twin-screw extruder at a head part temperature of 130° C. and then cooled.

The cooled product was coarsely ground into a 2-mm square or less, and 100 parts by weight of the coarsely ground product was added with stirring in a mixed organic solvent solution containing 150 parts by weight of toluene and 100 parts by weight of ethyl acetate to produce a uniformly mixed and dispersed solution working out to the oil phase.

Thereafter, 5 parts by weight of tricalcium phosphate fine powder which was thoroughly ground by a ball mill and in which particles having a particle size of 3 μm or more were not present, and 5 parts by weight of an aqueous 1 mass % sodium dodecylbenzenesulfonate solution were added to 1,100 parts by weight of ion exchanged water and then stirred to produce a uniformly mixed and dispersed solution working out to the aqueous phase.

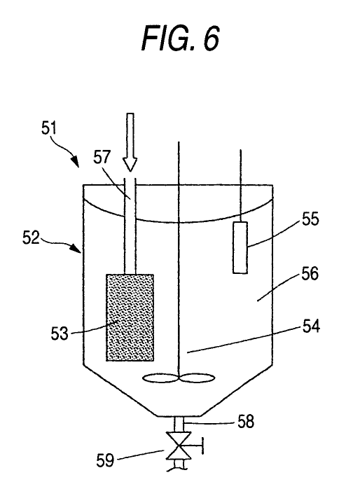

Subsequently, a suspended particle was prepared by using a suspended particle producing apparatus shown in FIG. 6.

The suspended particle producing apparatus 51 comprises an jetting part 53 formed of a porous body having a pore diameter of 3 μm, such as porous glass, a rotary stirrer 54 and an ultrasonic vibrator 55 in a suspension tank 52, and comprises a suspended particle outlet 58 and a switch valve 59 at the bottom of the suspension tank.

The dispersed solution 56 prepared above was charged into the suspension tank 52 and while stirring it by the stirrer 54, the dispersed solution as the oil phase prepared above was injected under pressure through a supply tube 57 combined with the jetting part 53.

At the same time, ultrasonic vibration was irradiated by the ultrasonic vibrator 55, whereby the particles jetted out from pores of the porous body were divided to form emulsion fine particles.

The stirring blades were rotated not to allow for coalescence of emulsion fine particles formed. The stirring was continued for 10 minutes even after the injection under pressure of the dispersed solution as the oil phase was completed.

Thereafter, the switch valve 59 was opened and the emulsion was taken out into a stirring tank from the outlet 58 at the bottom of the container. The emulsion taken out was kept at a temperature of 50° C. or more with stirring in the stirring tank to remove the organic solvent contained and then washed with SN hydrochloric acid. Thereafter, the emulsion was repeatedly washed and filtered, and then dried to obtain a cyan toner having a number mean particle size of 6.7 μm. In the cyan toner obtained, the cyan toner mother particle had a mean particle size of 7.5 μm on the volume basis, a mean particle size of 6.8 μm on the number basis, and a sphericity of 0.98. This cyan toner was designated as Toner Mother Particle 5. The work function of Toner Mother Particle 5 was measured by using a surface analyzer (Model AC-2, manufactured by Riken Keiki Co., Ltd.) with an irradiation light intensity of 500 nW and found to be 5.23 eV.

### Preparation of Toner Mother Particles 6, 7 and 8

Toner Mother Particle 6 which is a magenta toner was prepared in the same manner as in Production of Toner Mother Particle 5 except that a magenta pigment, Carmine 6B, was used in place of the cyan pigment in Toner Mother Particle 5. Also, Toner Mother Particle 7 which is a yellow toner was prepared in the same manner by changing the cyan pigment to a yellow pigment, Pigment Yellow 180.

Furthermore, Toner Mother Particle 8 which is a black toner was prepared in the same manner as in Production of Toner Mother Particle 5 except for using carbon black in place of the cyan pigment.

The average particle size, sphericity and work function of each of the color toner mother particles obtained, which were measured in the same manner, are shown in Table 1.

TABLE 1

| | Mean particle | Mean particle | | |
|---|---|---|---|---|
| | size on | size on | | Work |
| | Volume Basis | Number Basis | | Function |
| Mother Particle | (μm) | (μm) | Sphericity | (eV) |
| Toner Mother | 7.3 | 6.6 | 0.980 | 5.70 |
| Particle 6 | | | | |
| Toner Mother | 7.2 | 6.5 | 0.981 | 5.51 |
| Particle 7 | | | | |
| Toner Mother | 7.2 | 6.6 | 0.980 | 5.40 |
| Particle 8 | | | | |

As seen from the results in Table 1, the mean particle size and sphericity are uniformalized among the toners prepared differing in the color.

### Production Example of Organic Photoconductor (OPC 1)

An aluminum tube with a diameter of 30 mm was used as the electrically conducting support, and a coating solution prepared by dissolving and dispersing 6 parts by weight of alcohol-dissolvable nylon (CM8000, produced by Toray Industries, Inc.) and 4 parts by weight of aminosilane-treated titanium oxide fine particle in 100 parts by weight of methanol was coated thereon by the ring coating method and dried at a temperature of 100° C. for 40 minutes to form a subbing layer having a thickness of 1.5 to 2 μm.

Thereafter, a pigment dispersed solution obtained by dispersing 1 part by weight of oxytitanylphthalocyanine as a charge generation pigment, 1 part by weight of butyral resin (BX-1, produced by Sekisui Chemical Co., Ltd.) and 100 parts by weight of dichloroethane for 8 hours with use of a sand mill using glass beads of 41 mm was applied on the support by the ring coating method and dried at a temperature of 80° C. for 20 minutes to form a charge generation layer having a thickness of 0.3 μm on the subbing layer formed above.

Subsequently, a solution obtained by dissolving 40 parts by weight of a charge transport substance comprising a styryl compound represented by the following structural formula (1) and 60 parts by weight of polycarbonate resin (Panlite TS, produced by Teijin Chemicals Ltd.) in 400 parts by weight of toluene was applied by the dip coating method to have a dry thickness of 22 μm and then dried to form a charge transport layer on the charge generation layer. In this way, an organic photoconductor (OPC 1) having a photosensitive layer comprising two layers was produced.

A part of the organic photoconductor obtained was cut out and used as a specimen, and the work function thereof was measured by a commercially available surface analyzer (Model AC-2, manufactured by Riken Keiki Co., Ltd.) with an irradiation light intensity of 500 nW and found to be 5.47 eV.

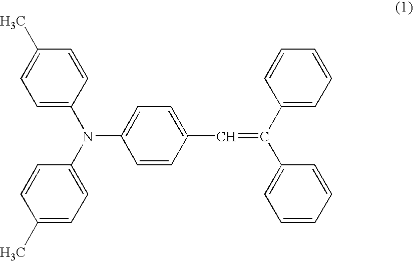

### Production Example of Organic Photoconductor (OPC 2)

An organic photoconductor (OPC 2) was produced in the same manner as the organic photoconductor (OPC 1) except for changing the charge generation pigment to titanylphthalocyanine and the charge transport substance to a distyryl compound represented by the following structural formula (2).

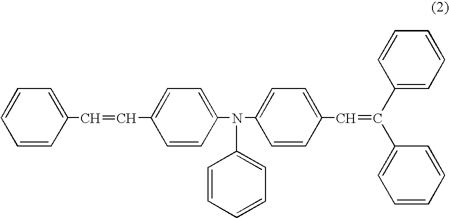

### Production of Development Roller

Nickel plating (thickness: 10 μm) was applied to the surface of an aluminum pipe having a diameter of 18 mm to give a surface having a surface roughness (Rz) of 4 μm. The work function of this development roller surface was measured and found to be 4.58 eV.

### Production of Regulating Blade

Electrically conducting urethane rubber chips with a thickness of 1.5 mm were bonded to a stainless steel sheet having a thickness of 80 μm by an electrically conducting adhesive, and the work function of the urethane part was set to 5 eV.

### Production Example of Intermediate Transfer Belt 1

85 Parts by weight of polybutylene terephthalate, 15 parts by weight of polycarbonate and 15 parts by weight of acetylene black were preliminary mixed by a mixer in a nitrogen gas atmosphere, and the obtained mixture was then kneaded by a twin-screw extruder in a nitrogen gas atmosphere to obtain a pellet. This pellet was extruded into a tubular film having an outer diameter of 170 mm and a thickness of 160 μm by a single-screw extruder with an annular die at a head temperature of 260° C.

The melt tube extruded was cooled and solidified while regulating the inner diameter by a cooling inside mandrel supported coaxially with the annular die to produce a seamless tube. By cutting the seamless tube, a seamless belt having an outer diameter of 172 mm, a width of 342 mm and a thickness of 150 μm was obtained. This seamless belt was designated as Intermediate Transfer Belt 1. The volume resistivity of this transfer belt was 3.2×10⁸ Ω·cm, the work function was 5.19 eV, and the normalized photoelectron yield was 10.88.

### Production Example of Intermediate Transfer Belt 2

A uniformly dispersed solution containing 30 parts by weight of vinyl chloride-vinyl acetate copolymer, 10 parts by weight of electrically conducting carbon black and 70 parts by weight of methyl alcohol was coated on an aluminum-deposited polyethylene terephthalate resin film having a width of 383 mm and a thickness of 130 μm by the roll coating method and dried to form an intermediate electrically conducting layer having a thickness of 20 μm.

Thereafter, a coating solution obtained by mixing and dispersing 55 parts by weight of nonionic aqueous urethane resin (solid ratio: 62 mass %), 11.6 parts by weight of polytetrafluoroethylene emulsion resin (solid ratio: 60 mass %), 25 parts by weight of electrically conducting tin oxide, 34 parts by weight of polytetrafluoroethylene fine particle (maximum particle size: 0.3 μm or less), 5 parts by weight of polyethylene emulsion (solid ratio: 35 mass %) and 20 parts by weight of ion exchanged water was coated on the intermediate electrically conducting layer similarly by the roll coating method to have a thickness of 10 μm and dried.

The resulting coated sheet was cut into a length of 540 mm, and the end parts thereof were joined by ultrasonic welding while arranging the coated surface outward to produce Intermediate Transfer Belt 2. The volume resistivity of this transfer belt was 2.5×10¹⁰ Ω·cm, the work function was 5.37 eV, and the normalized photoelectron yield was 6.9.

### Production Example of Cleaning Blades 1 and 2

Cleaning Blade (1) was produced by the following method and bonded to a metal-made support plate shown in FIG. 3B by a hot-melt adhesive to produce a cleaning device for the intermediate transfer body of the present invention.

The blade 35 shown in FIG. 3 comprises a urethane rubber having a hardness (JISA) of 67°±3° and for this blade, the thickness is 2 mm, the protrusion amount is 8 mm, the pressure contact utilizes a counter system, the pressure contact angle is 20°, the linear pressure at the operation is 23.15 N·m, and the load utilizes a spring pressure system.

An ester-based polyurethane which is a preferred constitution material of a cleaning blade was used as the polyurethane for the cleaning blade. More specifically, as raw materials of the urethane polymer, a polyester diol obtained by the dehydrating condensation of a poly-ε-caprolactone-based diol and an adipic acid, and 4′-diphenylmethane diisocyanate were mixed with 1,4-butanediol and trimethylolpropane by appropriately changing the blending ratio. Then, the resulting mixture was cast in a previously heated mold and then cured under heat. In this way, urethane rubbers differing in the physical values were produced and shaped.

In order to elevate the work function of the cleaning blade, hexamethylenediamine as a chain extending agent and triethanolamine as a polyfunctional component were added. After the shaping, each urethane rubber was cut by adjusting the width, thickness and length to produce a cleaning blade.

The work function of the cleaning blade produced was measured by using a surface analyzer (Model AC-2, manufactured by Riken Keiki Co., Ltd.) with an irradiation light intensity of 500 nW and found to be 5.03 eV. Also, the work function of Cleaning Blade 2 where the above-described amine was added was found to be 5.52 eV.

### Production Example of Roll Brushes 1 and 2

The roll brush used in the cleaning device for the intermediate transfer body of the present invention can be produced by the method described in JP-A-10-293439. A ribbon-like brush body prepared by pile-weaving a large number of electrically conducting brush bristles into a base cloth is spirally wound around a metal-made roll core by directing the pile-weaving direction orthogonal to the longitudinal direction of the brush body.

This electrically conducting brush bristle is formed from an electrically conducting fiber obtained by dispersing an electrically conducting material such as carbon black in a base material such as nylon, rayon, vinylon, polyester and acryl, and the resistance can be freely adjusted by the amount of the electrically conducting carbon material. The size of the electrically conducting fiber is 600 D/F, the weaving density is 100,000 F/inch², and the pile length is 6.5 mm. The base cloth comprises a polyester synthetic fiber consisting of a warp and a weft and having a size of 40/2. This base cloth is solid woven on a wide loom while W-weaving the electrically conducting fiber thereinto, whereby a pile-woven base cloth having a longitudinal weaving direction is obtained.

After the pile weaving of base cloth, an electrically conducting styrene butadiene rubber (SBR) is backcoated on the back surface of the base cloth. Then, the base cloth is cut into each slit width of 15 mm to form a ribbon-like brush body. The roll core has a shaft diameter of 6 mm, and the construction material thereof is SUM plated by the Kanigen process. A double-coated adhesive tape is wound around the roll core, and the ribbon-like brush body is spirally wound around on this double-coated adhesive tape. Thereafter, the brush roll is subjected to straightening of bristles and comes to have an outer diameter of 15 mm, thereby completing the roll brush, that is, fur brush.

When the roll brush was produced by selecting various synthetic fibers (produced by Toei Sangyo Co., Ltd.) for the electrically conducting fiber and measured, the work function was 4.80 eV with nylon-type UNN, 4.93 eV with GBN, 4.95 eV with vinylon-type USV, and 5.70 eV with polyester-type 4KC.

Among these, Roll Brush 1 using USV and having a work function of 4.95 eV, and Roll Brush 2 using 4KC and having a work function of 5.70 eV were selected as the brush roll for use in the present invention and evaluated in the image formation test.

### Production Example 1 of Toner

First, 0.8 parts by weight of hydrophobic silica having a mean primary particle size of 12 nm, which is a fluidity improving agent, and 0.7 parts by weight of hydrophobic silica having a mean primary particle size of 40 nm were added and mixed per 100 parts by weight of Toner Mother Particle 1 to prepare a toner.

Thereafter, toners containing 0.4 parts by weight of monodisperse spherical silica having a mean particle size distribution shown in Table 2, 0.5 parts by weight of hydrophobic titanium oxide of 20 nm, 0.2 parts by weight of hydrophobic titanium oxide having a particle size distribution of 200 to 750 nm in terms of the primary particle size and being treated with a negatively chargeable n-butyltrimethoxysilane coupling agent and further with zinc stearate, and 0.2 parts by weight of metal soap (fine particulate calcium stearate (M7StCa), produced by NOF Corporation) shown in Table 4 were produced and designated as Toner 1-1, Toner 1-2 and Toner 1-3, respectively. For comparison, Toner C1, Toner C2 and Toner C3 where metal soap was not added were also prepared.

TABLE 2

| | Mean | True | Bulk | Work |
|---|---|---|---|---|
| Monodisperse | particle size | Specific | Specific | Function |
| Silica | (nm) | Gravity | Gravity | (eV) |
| A | 70 to 130 | 2.0 | 0.2 | 5.07 |
| B | 260 to 320 | 2.0 | 0.3 | 5.01 |
| C | 480 to 580 | 2.0 | 0.3 | 5.08 |

The toners obtained each was charged into a non-contact developing device for cyan toner of a tandem-type color printer shown in FIG. 2A or FIG. 2B comprising a development roller, a regulating blade, a cleaning blade or a roll brush, OPC 1 and an intermediate transfer belt which were produced as above, and evaluated.

The toner amount on the development roller was regulated to 0.4 to 0.43 mg/cm² and after printing an entire white solid image on one sheet of A3-size paper and an entire solid original on one sheet of A3-size paper, the electric charge property on the development roller was examined. Thereafter, idling-mode printing of 2,500 sheets in the phase of A4-size white paper or the like was performed and then a solid image was formed to determine the transfer efficiency from the organic photoconductor to the intermediate transfer belt. Also, the number liberation ratio of external additive was measured. The results are shown in Table 3.

In the tape transfer method, a mending tape (produced by Sumitomo 3M Ltd.) was attached to the toner on the organic photoconductor before and after transfer to allow for adhesion of the toner to the tape and then peeled off, and the transfer efficiency was determined based on the value obtained by subtracting the amount of untransferred toner from the amount of toner used for development on the organic photoconductor.

The electric charge property was determined by measuring the detached development roller with use of a charge amount distribution meter (E-SPART Analyzer Model EST-3, manufactured by Hosokawa Micron Corporation). The liberation ratio of external additive was measured by a fine particle analyzer (Particle Analyzer PT1000, manufactured by Yokogawa Electric Corporation).

The liberation ratio is calculated from the number of detected pieces of the measured element and defined by the following formula:
Liberation ratio=(detected number of liberated additive particles/detected number of all additive particles)×100%

As for other image-forming conditions, the primary-transfer part was applied with DC+500 V from a constant voltage source, the image-forming rate of the printer was 40 ppm, the ratio of the peripheral velocity of the development roller to the peripheral velocity of the organic photoconductor was 1.3, and the difference in the peripheral velocity between the organic photoconductor and the intermediate transfer belt was set to rotate the intermediate transfer belt at a 3% higher velocity.

TABLE 3

| | Negative | | Number | | Transfer |
|---|---|---|---|---|---|
| | Charge | | Liberation | | Efficiency after |
| | Amount | +Toner Amount | Ratio (%) | | Idle Printing |
| Toner | (μc/g) | (% by number) | Si | Ti | (%) |
| Toner 1-1 | −12.79 | 4.1 | 0.61 | 16.04 | 93.7 |
| Toner 1-2 | −12.86 | 4.6 | 0.64 | 10.37 | 99.2 |
| Toner 1-3 | −13.07 | 4.0 | 0.61 | 8.04 | 97.7 |
| Toner C1 | −12.53 | 8.9 | 0.69 | 18.72 | 92.5 |
| Toner C2 | −12.60 | 9.1 | 0.72 | 15.63 | 98.3 |
| Toner C3 | −12.70 | 8.7 | 0.69 | 13.29 | 95.1 |

As seen from the evaluation results above, the electric charge property was not changed depending on the particle size of monodisperse spherical silica but with respect to the transfer efficiency after the idling-mode endurance test, Toner 1-2 using monodisperse spherical silica having a particle size of 260 to 320 nm maintained a transfer efficiency of 99% or more and was revealed to have excellent durability.

On the other hand, in Toner C2 where metal soap was not added, the transfer efficiency after idling was as low as 98.3%. Also, in this and other comparative toners, the +toner amount (% by number) was nearly a double, revealing readily occurrence of fogging and suggesting that the external additive was liberated from the toner and the electric charge property was not stabilized. This is also supported by the results of number liberation ratio (%). The tendency of not easily allowing for liberation of an inorganic external additive with a large particle size was stronger in the case of using Monodisperse Spherical Silica 2 or 3 than in the case of using Monodisperse Spherical Silica 1.

Details of the metal soap used in the present invention are shown in Table 4.

TABLE 4

| | | Work | Normalized |
|---|---|---|---|
| | | Function | Photoelectron |
| Metal Soap | Abbreviation | (eV) | Yield |
| Monoaluminum stearate | M1StAl | 5.21 | 1.1 |
| Zinc stearate | M2StZn | 5.64 | 4.0 |
| Magnesium stearate | M3StMg | 5.57 | 8.6 |
| Calcium stearate | M4StCa | 5.49 | 5.1 |
| Fine particulate magnesium | M5StMg | 5.58 | 7.0 |
| stearate | | | |
| Fine particulate zinc stearate | M6StZn | 5.36 | 5.6 |
| Fine particulate calcium | M7StCa | 5.32 | 5.5 |
| stearate | | | |
| Trialuminum stearate | M8StAl | 5.17 | 1.9 |

Note 1: Monoaluminum stearate, Zinc stearate, Magnesium stearate and Calcium stearate set forth are manufactured by Kanto Kagaku.
Note 2: Fine particulate magnesium stearate, Fine particulate zinc stearate, Fine particulate calcium stearate and Trialuminum stearate are manufactured by NOF Corporation.

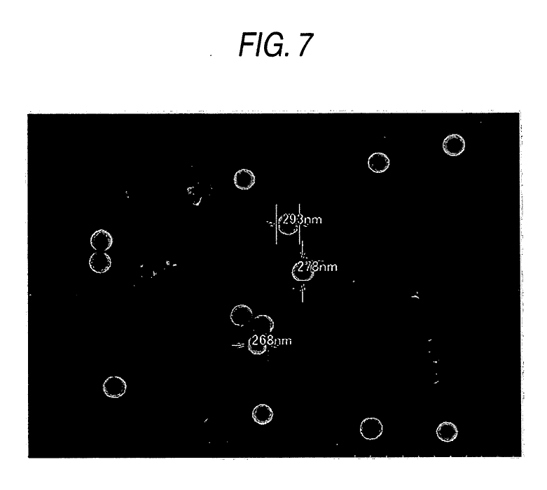

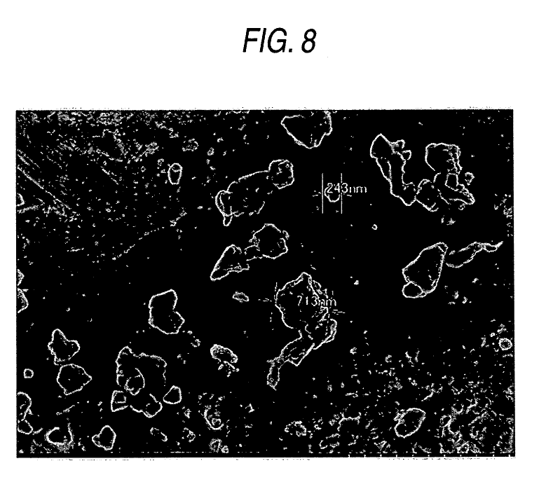

The scanning electron microphotographs of mono-disperse spherical silica and titanium oxide with a large particle size used in this Example are shown in FIGS. 7 and 8, respectively.

The particle size of the monodisperse silica within the photograph range was from 263 to 293 nm in terms of the primary particle size, and the particle size of the titanium oxide within the photograph range was from 243 to 713 nm in terms of the primary particle size.

### Example 2

Toners containing 0.7 parts by weight of hydrophobic silica having a mean primary particle size of 7 nm, which is a fluidity improving agent, 0.6 parts by weight of hydrophobic silica having a mean primary particle size of 40 nm, 0.4 parts by weight of hydrophobic titanium oxide having a mean primary particle size of 20 nm, 0.4 parts by weight of Monodisperse Spherical Silica 2 shown in Table 2, which was hydrophobed with a hexamethyldisilazane coupling agent, 0.2 parts by weight of hydrophobic titanium oxide having a particle size distribution of 200 to 750 nm in terms of the primary particle size and being treated with a negatively chargeable n-butyltrimethoxysilane coupling agent and further with zinc stearate, and 0.2 parts by weight of metal soap shown in Table 5, per 100 parts by weight of Toner Mother Particle 2 (mean particle size on the volume basis: 7.9 μm, mean particle size on the number basis: 7.0 μm, work function: 5.64 eV, sphericity: 0.976) of Example 1 were prepared.

TABLE 5

| | | | | | | Transfer |
|---|---|---|---|---|---|---|
| | | | | Number | | Efficiency |
| | Metal | Negative | +Toner | Liberation | | after |
| | Soap/Work | Charge | Amount | Ratio | | Idle |
| | Function | Amount | (% by | (%) | | Printing |
| Toner | (eV) | (μc/g) | number) | Si | Ti | (%) |
| Toner 2-1 | M2StZn/ | −12.33 | 4.3 | 0.69 | 10.61 | 99.1 |
| | 5.64 | | | | | |
| Toner 2-2 | M3StMg/ | −13.16 | 3.9 | 0.68 | 11.72 | 99.1 |
| | 5.57 | | | | | |
| Toner 2-3 | M4StCa/ | −12.64 | 4.5 | 0.67 | 10.57 | 99.3 |
| | 5.49 | | | | | |
| Toner C4 | not added | −12.57 | 8.8 | 0.71 | 15.39 | 96.7 |
| Toner C5 | M1StAl/ | −8.93 | 12.2 | 0.68 | 10.22 | 95.1 |
| | 5.21 | | | | | |

As seen from the results above, the liberation ratio of external additive was liable to decrease by the addition of a metal soap as compared with the case of not adding a metal soap, but when the work function of metal soap was 5.21 eV, the negative charge amount was −8.93 μc/g and lower than others despite the addition of the metal soap and also, the +toner amount was as large as a double or more, as a result, the transfer efficiency after the idling-mode endurance test was 95.1% and worst. It is understood that in elevating the transfer efficiency, good results are not obtained only by merely adding a metal soap but obtained when a metal soap having a work function of at least 5.25 eV, preferably 5.3 eV or more, is added.

### Example 3

Toners containing 0.8 parts by weight of hydrophobic silica having a mean primary particle size of 12 nm, which is a fluidity improving agent, 0.2 parts by weight of hydrophobic silica having a mean primary particle size of 40 nm, 0.4 parts by weight of hydrophobic titanium oxide having a mean primary particle size of 20 nm, 0.1 part by weight of metal soap M6StZn (work function: 5.36 eV) shown in Table 4, 0.4 parts by weight of Monodisperse Spherical Silica 2 shown in Table 2, which was hydrophobed, and 0.2 parts by weight of one of the inorganic external additives shown in Table 5 differing in the particle size distribution range of the primary particle size, per 100 parts by weight of Toner Mother Particle 5 (work function: 5.23 eV, sphericity: 0.98, mean particle size: 6.8 μm) of Example 1 were prepared.

In the Table, Inorganic External Additives 1 and 2 are titanium oxide and Inorganic External Additives 3 and 4 are strontium titanate. Each external additive was surface-treated with a silane coupling agent and further treated with a metal soap to impart negative polarity to the external additive.

The electric charge property of toner on the development roller, the liberation ratio of external additive from the toner mother particle, and the transfer efficiency after idling were determined in the same manner as in Example 1. The results are shown in Table 6. In the Table, the number liberation ratio is shown for Ti and Sr which are more readily liberated than Si.

TABLE 6

| | | | | | Number | | Transfer |
|---|---|---|---|---|---|---|---|
| | Inorganic External Additive | | Negative | | Liberation | | Efficiency after |
| | Particle size | Work Function | Charge Amount | +Toner Amount | Ratio (%) | | Idle Printing |
| Toner | Range (nm) | (eV) | (μc/g) | (% by number) | Ti | Sr | (%) |
| Toner 5-1 | 80-150 | 5.42 | −8.11 | 4.1 | 8.84 | — | 98.1 |
| Toner 5-2 | 230-750 | 5.41 | −8.33 | 4.5 | 13.27 | — | 99.6 |
| Toner 5-3 | 60-280 | 5.49 | −7.94 | 3.5 | — | 9.22 | 98.7 |
| Toner 5-4 | 250-700 | 5.48 | −8.52 | 2.8 | — | 13.51 | 99.8 |

As seen from the evaluation results above, when a negatively chargeable inorganic external additive with a large particle size was added, the transfer efficiency of the solid image after the idling-mode endurance test was Toner 5-1, Toner 5-4>Toner 5-1, Toner 5-3, though there was no difference in the electric charge property. It seems that an organic external additive smaller than the particle size distribution range of 260 to 320 nm in terms of the primary particle size of the monodisperse spherical silica tends to be easily buried in the surface of the toner mother particle in the severe endurance test.

This reveals that when the primary particle size of the monodisperse spherical silica has a particle size distribution range of 260 to 320 nm, the primary particle size of the negatively chargeable inorganic external additive added preferably has a particle size distribution range from at least equal to the particle size of the monodisperse spherical silica to 2.5 times the particle size of the monodisperse spherical silica.

Also, it was confirmed by a separate test that if particles having a particle size distribution exceeding the upper limit, that is, 2.5 times, are contained, the number liberation ratio increases and stable electric charge property cannot be imparted to the toner mother particle over a long period of time. When exceeded 800 nm, the liberation ratio became 30% or more, and the external additive tended to adhere to the organic photoconductor surface, development roller, regulating blade and the like.

### Example 4

Hydrophobic silica having a mean primary particle size of 12 nm, which is a fluidity improving agent, and Monodisperse Spherical Silica 2 shown in Table 2, which was hydrophobed, were mixed at a ratio shown in Table 7 and added in a total amount of 1.2 parts by weight to 100 parts by weight of Toner Mother Particle 7 (work function: 5.51 eV, sphericity: 0.981, mean particle size: 6.5 μm) of Example 1 to prepare toners.

The toners obtained were designated as Toner 7-1, Toner 7-2 and Toner 7-3. As for the kinds and added amounts of other external additives, 0.1 part by weight of hydrophobic titanium oxide having a mean primary particle size of 20 nm, 0.1 part by weight of metal soap M5StMg (work function: 5.58 eV) shown in Table 4, and 0.5 parts by weight of negatively charged hydrophobic titanium having a primary particle size of 230 to 750 nm were contained. Also, Toner 7-4 was prepared by changing the amount of this hydrophobic titanium oxide to 0.7 parts by weight.

The electric charge property of toner on the development roller, the liberation ratio of external additive from the toner mother particle, and the transfer efficiency after idling were determined in the same manner as in Example 1. The results are shown in Table 7.

TABLE 7

| | Amount Added of Inorganic | | | | | | |
|---|---|---|---|---|---|---|---|
| | External Additive | | | | Number | | Transfer |
| | (% by weight) | | Negative | | Liberation | | Efficiency after |
| | Hydrophobic | Monodisperse | Charge Amount | +Toner Amount | Ratio (%) | | Idle Printing |
| Toner | Silica of 12 nm | Silica | (μc/g) | (% by number) | Si | Ti | (%) |
| Toner 7-1 | 0.5 | 0.7 | −8.10 | 9.4 | 044 | 31.43 | 98.1 |
| Toner 7-2 | 0.8 | 0.4 | −11.21 | 4.0 | 0.68 | 18.51 | 99.7 |
| Toner 7-3 | 1.0 | 0.2 | −11.36 | 2.4 | 0.65 | 17.19 | 99.1 |
| Toner 7-4 | 1.0 | 0.2 | −11.27 | 3.1 | 0.63 | 29.67 | 98.5 |

As seen from the evaluation results above, along with decrease in the amount added of Monodisperse Spherical Silica 2, the negative charge amount of toner was increased and the +toner amount tended to decrease, but when the amount of the inorganic external additive with a large particle size was increased from 0.5 parts by weight to 0.7 parts by weight, the number liberation ratio of titanium was increased and the transfer efficiency of solid image after the idling-mode endurance test was decreased.

Therefore, it is revealed that when the inorganic external additive having a large work function is added in an amount larger than the amount of monodisperse spherical silica, this causes easy liberation of the external additive from the toner mother particle and in turn, reduction in the function of transferring the toner on the organic photoconductor surface to the intermediate transfer belt in continuous printing.

### Example 5

The metal soap combined with Toner Mother Particle 1, 2, 3 or 4 of Example 1 was changed as shown in Table 8 and external additives were added to the toner mother particle according to the following formulation.

Toners containing 0.8 parts by weight of hydrophobic silica having a mean primary particle size of 12 nm, 0.7 parts by weight of hydrophobic silica having a mean primary particle size of 40 nm, 0.4 parts by weight of Monodisperse Spherical Silica 2 shown in Table 2, which was hydrophobed, 0.5 parts by weight of hydrophobic titanium oxide of 20 nm, 0.5 parts by weight of negatively chargeable titanium oxide having a primary particle size in the particle size distribution range of 200 to 750 nm, and 0.2 parts by weight of metal soap shown in Table 8, per 100 pats by weight of each toner mother particle were prepared.

TABLE 8

| Toner Mother Particle/Work Function | Metal Soap/Work Function |
|---|---|
| Cyan Toner 1/5.57 eV | M3StMg/5.57 eV |
| Magenta Toner 2/5.64 eV | M2StZn/5.64 eV |
| Yellow Toner 3/5.59 eV | M5StMg/5.58 eV |
| Black Toner 4/5.52 eV | M4StCa/5.49 eV |

Each color toner prepared was charged into the corresponding development cartridge of a tandem-type color printer shown in FIG. 2 and subjected to a continuous image forming test.

In the development, a non-contact development system was employed and the development was performed in order of decreasing the work function of toner, that is, magenta toner, yellow toner, cyan toner and black toner, from the upstream side in the traveling direction of the intermediate transfer belt. However, the system was designed so that the printing could be performed whichever the development by the black toner came first or last in order. When the order of development was changed, the order of image processing was changed.

The developing gap was 200 μm, and the developing bias was adjusted by patch control such that the amount of the developing toner was maximally 0.55 mg/cm² per one color on the organic photoconductor. The frequency of AC voltage superimposed on DC voltage was 2.5 kHz, the P-P voltage was 1,400 V, and the amount of toner regulated on the development roller was adjusted to about 4 mg/cm². The power source of the primary-transfer part was under constant voltage control to apply +500 V, and the power source of the secondary-transfer part was under constant current control.

Image formation was continuously performed on 10,000 sheets by using a character original corresponding to a color original with 5% each color containing a character and a color line image. After the completion of image formation, the filming amount on the organic photoconductor was determined by the tape transfer method and found to be 0.0052 mg/cm². Thus, almost no generation of filming could be confirmed.

However, when a the metal soap was changed to trialuminum stearate (work function: 5.17 eV) shown in Table 4 and when a developer prepared by not adding Monodisperse Spherical Silica 2 shown in Table 2 was used, the filming amount after printing of 10,000 sheets was 0.016 mg/cm² and 0.011 mg/cm², respectively. The state thereof was such that thin filming was observed and when a 30% halftone original was printed, an image quality with occurrence of unevenness on the entire surface resulted.

Also, image formation by disposing the developing cartridge containing the black toner first in the development order was examined. When composite black was not produced, the filming amount on the organic photoconductor was 0.0061 mg/cm² and this was an amount causing utterly no problem in forming an image by a cleanerless system.

### Example 6

The metal soap combined with Toner Mother Particle 5, 6, 7 or 8 of Example 1 was changed as shown in Table 9 and external additives were added to the toner mother particle according to the following formulation.

Toners containing 0.8 parts by weight of hydrophobic silica having a mean primary particle size of 12 nm, 0.1 part by weight of hydrophobic silica having a mean primary particle size of 40 nm, 0.4 parts by weight of Monodisperse Spherical Silica 2 shown in Table 2, which was hydrophobed, 0.5 parts by weight of hydrophobic titanium oxide of 20 nm, 0.2 parts by weight of negatively chargeable titanium oxide having a primary particle size in the particle size distribution range of 230 to 750 nm, and 0.1 part by weight of metal soap shown in Table 8, per 100 pats by weight of each toner mother particle were prepared.

TABLE 9

| Toner Mother Particle/Work Function | Metal Soap/Work Function |
|---|---|
| Cyan Toner 5/5.23 eV | M7StCa/5.32 eV |
| Magenta Toner 6/5.70 eV | M2StZn/5.64 eV |
| Yellow Toner 7/5.51 eV | M4StCa/5.49 eV |
| Black Toner 8/5.40 eV | M6StZn/5.36 eV |

Each color toner prepared was charged into the corresponding development cartridge of a cleanerless four-cycle color printer shown in FIG. 3 and subjected to a continuous printing test. In the development, a non-contact development system was employed and the development was performed in order of decreasing the work function of toner, that is, magenta toner, yellow toner and cyan toner, from the upstream side in the traveling direction of the intermediate transfer belt. The development order was set to start the development first from the black toner.

The developing gap was 170 μm, and the developing bias was adjusted by patch control such that the amount of the developing toner was maximally 0.55 mg/cm² per one color on the organic photoconductor. The frequency of AC voltage superimposed on DC voltage was 2.5 kHz, the P-P voltage was 1,300 V, and the amount of toner regulated on the development roller was adjusted to 4 mg/cm².

The power source of the primary-transfer part was under constant voltage control to apply +400 V, and the power source of the secondary-transfer part was under constant current control. In this printer of FIG. 3, the development roller and regulating blade were produced as described in Example 1, and Cleaning Blade 1, organic photoconductor OPC 2 and Intermediate Transfer Belt 2 were mounted.

A continuous image formation test was performed on 10,000 sheets by using a character original corresponding to a color original with 5% each color containing a character and a color line image. After the completion of image formation test, the filming amount on the organic photoconductor was determined by the tape transfer method and found to be 0.0057 mg/cm². Thus, almost no generation of filming could be confirmed.

### Example 7

Cyan Toner 5-1 (mean particle size of toner mother particle on the volume basis: 7.5 μm, mean particle size on the number basis: 6.8 μm, sphericity: 0.98, work function: 5.23 eV) of Example 3 and Yellow Toner 7 (mean particle size of toner mother particle on the volume basis: 7.2 μm, mean particle size on the number basis: 6.5 μm, sphericity: 0.981, work function: 5.51 eV) of Example 6 each was charged into the corresponding color developing cartridge of a cleanerless tandem-type color printer shown in FIG. 2 and subjected to a continuous monochromatic image formation test. For the intermediate transfer belt, cleaning blade 1 having a work function of 5.03 eV and cleaning blade 2 having a work function of 5.52 eV, or roll brush 1 having a work function of 4.95 eV and roll brush 2 having a work function of 5.70 eV shown in Example 1, were used and compared. An electrophotographic plain paper copier (Paper J, produced by Fuji Xerox Office Supply) was used for the transfer sheet, and the transfer was performed under such a condition that the transfer current of the secondary-transfer part was 15 μA.

The continuous image formation test was performed on 1,000 sheets by using a character original corresponding to a color original with 5% each color containing a character and a color line image under in an environment at room temperature of 23° C. and a relative humidity of 50%. Also, a yellow solid image was printed and the transfer efficiency in the secondary-transfer part was determined by the tape transfer method. The results are shown in Tables 10A and 10B.

TABLE 10A

| | | | Transfer |
|---|---|---|---|
| | Cleaning | | Efficiency |
| | Blade/ | Surface State of | of Secondary- |
| | Work Function | Intermediate Transfer | Transfer Part |
| Toner | (eV) | Belt After Test | (%) |
| Cyan | Blade 1/ | none of attachment, foreign | 92.7 |
| Toner 5-1 | 5.03 | matter, etc. | |
| | Blade 2/ | slightly attached with toner | 92.6 |
| | 5.52 | fine particle | |
| Yellow | Blade 1/ | none of attachment, foreign | 95.3 |
| Toner 7 | 5.03 | matter, etc. | |
| | Blade 2/ | slightly attached with toner | 95.4 |
| | 5.52 | fine particle | |

TABLE 10B

| | Roll Brush/ | | Transfer Efficiency |
|---|---|---|---|
| | Work | Surface State of | of Secondary- |
| | Function | Intermediate Transfer | Transfer Part |
| Toner | (eV) | Belt After Test | (%) |
| Cyan | Brush 1/ | none of attachment, foreign | 92.7 |
| Toner | 4.95 | matter, etc. | |
| 5-1 | Brush 2/ | slightly attached with toner | 92.6 |
| | 5.70 | fine particle | |
| Yellow | Brush 1/ | none of attachment, foreign | 95.3 |
| Toner 7 | 4.95 | matter, etc. | |
| | Brush 2/ | slightly attached with toner | 95.4 |
| | 5.70 | fine particle | |

As seen from the results shown in Table 10A, when a cleaning blade (5.03 eV) having a work function smaller than that of hydrophobic inorganic fine particle with a large particle size (primary particle size: 230 to 750 nm, work function: 5.41 eV) was used for the cleaning blade, filming and cleaning failure were not observed on the intermediate transfer belt, but when a blade having a large work function (5.52 eV) was employed, a toner fine particle was attaching to the image transfer belt surface. This problem is considered to occur because a toner fine particle having a high sphericity is present in the toner.

When a cleaning blade having a work function smaller than that of the hydrophobic inorganic fine particle with a large particle size is employed, this external additive with a large particle size seems to gather around the cleaning blade nip and adhere or fixedly attach thereto, as a result, the cleaning property is enhanced.

Also, as seen from the results shown in Table 10B, when a roll brush (5.03 eV) having a work function smaller than that of hydrophobic inorganic fine particle with a large particle size (primary particle size: 230 to 750 nm, work function: 5.41 eV) was used for the roll brush, filming and cleaning failure were not observed on the intermediate transfer belt, but when a roll brush having a large work function (5.52 eV) was employed, a toner fine particle was attaching to the image transfer belt surface. This problem is considered to occur because a toner fine particle having a high sphericity is present in the toner.

When a roll brush having a work function smaller than that of the hydrophobic inorganic fine particle with a large particle size is employed, this external additive with a large particle size seems to gather around the roll brush nip and adhere or fixedly attach thereto, as a result, the cleaning property is enhanced.

### Example 8

### Production of Toner Mother Particle 9

In producing Toner Mother Particle 5 of Example 1 by the suspension method, the injection speed of the oily component into the suspension tank was decreased to produce Cyan Toner Mother Particle 9 having a mean particle size of 7.4 μm on the volume basis, a mean particle size of 6.7 μm on the number basis, a sphericity of 0.991 and a work function of 5.24 eV.

### Production of Toner Mother Particle 10

A mixture containing 5 parts by weight of phthalocyanine blue as a cyan pigment, 3 parts by weight of propylene as a release agent having a melting point of 152° C. and a weight average molecular weight Mw of 4,000, and 4 parts by weight of a metal complex of salicylic acid (E-81, produced by Orient Chemical Industries, Ltd.) as a charge control agent was uniformly mixed by a Henschel mixer with 100 parts by weight of a 50:50 (by weight) mixture (produced by Sanyo Chemical Industries, Ltd.) of a polycondensate polyester (obtained from an aromatic dicarboxylic acid and an alkylene etherified bisphenol A) and a partially crosslinked product of the polycondensate polyester with a polyvalent metal compound, and then kneaded by a twin-screw extruder at a head part temperature of 150° C. After cooling, the cooled product was coarsely ground into a 2-mm square or less, and thereafter classified by a classifier utilizing rotation of a rotor to prepare Toner Mother Particle 10 as a cyan toner. This toner mother particle had a mean particle size of 7.8 μm on the volume basis, a mean particle size of 6.9 μm on the number basis, a sphericity of 0.911 and a work function of 5.43 eV.

### Preparation of Positively Charged Amorphous Fine Particle

A fine particle having a particle size range of 0.2 to 1.2 μm in terms of the primary particle size was prepared by using 100 parts by weight of a styrene acryl copolymer (CPR-600B, produced by Mitsui Chemicals, Inc.) and 5 parts by weight of a polymer-type charge control agent for positive charging (FCA-201-PS, produced by Fujikura Kasei Co., Ltd.), and performing melting, kneading, grinding and classification in the same manner as in Preparation of Toner Mother Particle 10.

Toners containing 0.8 parts by weight of hydrophobic silica having a mean primary particle size of 12 nm, 0.2 parts by weight of hydrophobic silica having a mean primary particle size of 40 nm, 0.4 parts by weight of hydrophobic titanium oxide having a mean primary particle size of 20 nm, 0.1 part by weight of metal soap M6StZn (work function: 5.36 eV) shown in Table 4, 0.4 parts by weight of Monodisperse Spherical Silica 2 shown in Table 2, which was hydrophobed, and 0.2 parts by weight of the amorphous fine particle shown in Table 11, per 100 parts by weight of each toner mother particle obtained above were prepared in the same manner as in Example 3.

Thereafter, an image forming test was performed in the same manner as in Example 1 by using a cleanerless tandem-type color printer of FIG. 2A employing Cleaning Blade 1 and a cleanerless tandem-type color printer of FIG. 2B employing Roll Brush 1. After a character original corresponding a color original with 5% each color containing a character and a color line image was printed on 2,500 sheets by idling-mode printing, the generation of filming on the organic photoconductor (OPC 1) and the leaning failure on the intermediate transfer belt 1 were observed with an eye. Each results obtained are shown in Tables 11A and 11B.

TABLE 11A

| | Sphericity | | | |
|---|---|---|---|---|
| | of Toner | | | |
| Toner Mother | Mother | Amorphous | | Cleaning |
| Particle | Particle | Fine Particle | Filming | Failure |
| Toner Mother | 0.980 | same as in Table 6 | almost no | none |
| Particle 5 | | | filming | |
| Toner Mother | 0.991 | ″ | almost no | partially |
| Particle 9 | | | filming | present |
| Toner Mother | 0.911 | ″ | thinly | none |
| Particle 10 | | | generated | |
| Toner Mother | 0.980 | positively charged | fairly | none |
| Particle 5 | | resin fine particle | generated | |

TABLE 11B

| | Sphericity | | | |
|---|---|---|---|---|
| | of Toner | Amorphous | | |
| Toner Mother | Mother | Fine | | Cleaning |
| Particle | Particle | Particle | Filming | Failure |
| Toner Mother | 0.980 | same as in Table 6 | almost no | none |
| Particle 5 | | | filming | |
| Toner Mother | 0.991 | ″ | almost no | none |
| Particle 9 | | | filming | |
| Toner Mother | 0.911 | ″ | thinly | none |
| Particle 10 | | | generated | |
| Toner Mother | 0.980 | positively charged | fairly | none |
| Particle 5 | | resin fine particle | generated | |

As seen from the results shown in Table 11A, in the case of a cleanerless system, when the sphericity of the toner mother particle was 0.911, filming was generated on the organic photoconductor. Even when the sphericity was 0.980, if a fine particle having a polarity opposite the toner mother particle was contained, filming was similarly generated. As for the cleaning property on the intermediate transfer belt, when the sphericity of the toner mother particle was 0.991, cleaning failure occurred.

In the case of a cleaning blade system, when a toner mother particle having a sphericity of 0.99 or more was used, cleaning failure occurred. Even when the sphericity was 0.980, if an amorphous fine particle having a polarity opposite the toner mother particle was used as an external additive, filming was generated.

Accordingly, it is revealed that use of a toner mother particle having a sphericity of 0.970 to 0.985 and an amorphous fine particle having the same polarity as the toner mother particle is advantageous to a cleanerless image forming apparatus using a cleaning blade for the image transfer belt.

As seen from the results shown in Table 11B, in the case of a cleanerless system, when the sphericity of the toner mother particle was 0.911, filming was generated on the organic photoconductor. Even when the sphericity was 0.980, if a fine particle having a polarity opposite the toner mother particle was contained, filming was similarly generated. As for the cleaning property on the intermediate transfer belt, even when the sphericity of the toner mother particle was 0.991, cleaning failure did not occur.

This is considered to occur because even if a toner mother particle having a sphericity of 0.991 is used, when a brush roll having a small work function is used, the inorganic fine particle contained as an external additive is held in the nip part of the roll brush to enhance the cleaning performance and at the same time, the toner mother particle is also liable to electrostatically (could be also said electronically) move to the brush side, as a result, the cleaning capacity is synergistically enhanced.

Accordingly, it is revealed that even if the sphericity of the mother toner particle is from 0.970 to 0.995, when an amorphous fine particle having the same polarity as the toner mother particle and a roll brush having a work function smaller than the amorphous fine particle are employed, a cleanerless system can be realized.

According to the toner of the present invention, an inorganic external additive with a large particle size is transferred together with the toner mother particle onto an intermediate transfer medium, so that the transfer efficiency to a recording material such as paper in the secondary-transfer part can be elevated. Furthermore, the inorganic fine particle with a large particle size is an external additive having a work function larger than the cleaning blade or a roll brush for the intermediate transfer medium and electrostatically adheres or fixedly attaches to the periphery including the nip part of the cleaning blade or a roll brush, so that the intermediate transfer medium can be efficiently cleaned to remove the untransferred toner fine particle remaining on the intermediate transfer medium or paper powders from the recording material. As a result, a printed matter having high image quality without back staining or transfer failure can be obtained.

While the present invention has been described in detail and with reference to specific embodiments thereof, it will be apparent to one skilled in the art that various changes and modifications can be made therein without departing the spirit and scope thereof.

The present application is based on Japanese Patent Applications No. 2004-083951 filed on Mar. 23, 2004 and No. 2004-084933 filed on Mar. 23, 2004, and the contents thereof are incorporated herein by reference.

1. A toner comprising:
a toner mother particle;
an amorphous fine particle;
a monodisperse spherical silica; and
a metal soap,
wherein the amorphous particle has the same polarity as the toner mother particle, a volume mean particle size of 0.1 times or less that of the toner mother particle, and a work function larger than that of a cleaning blade of a developing device,
wherein an average sphericity of the toner mother particle L₀/L₁ is from 0.970 to 0.985, provided that L₁ represents a circumferential length (μm) of a projected image of the particle, and L₀ represents a circumferential length (μm) of a true circle having an area equal to that of the projected image of the particle.

2. The toner according to claim 1, which further comprising first hydrophobic inorganic fine particle having a mean particle size of 7 to 50 nm,
wherein the monodisperse spherical silica has a work function of less than 5.1 eV and a particle size of 260 to 320 nm,
wherein the amorphous fine particle comprises second hydrophobic inorganic fine particle having the same polarity as the toner mother particle, a volume mean particle size of 0.1 times or less that of the toner mother particle, and a work function larger than that of the monodisperse spherical silica,
wherein the metal soap has a work function of 5.25 to 5.7 eV,
wherein the toner is a non-magnetic single-component negative-charged toner.

3. The toner according to claim 2, which further comprising a titanium oxide of which surface is hydrophobilized,
wherein the second inorganic fine particle has a primary particle size distribution of 200 to 750 nm.

4. The toner according to claim 1,
wherein the toner mother particle is obtained by a polymerization method or a dissolution suspension method.

5. A toner comprising:
a toner mother particle;
an amorphous fine particle;
a monodisperse spherical silica; and
a metal soap,
wherein the amorphous particle has the same polarity as the toner mother particle, a volume mean particle size of 0.1 times or less that of the toner mother particle, and a work function larger than that of a roll brush of a developing device,
wherein an average sphericity of the toner mother particle L₀/L₁ is from 0.970 to 0.995, provided that L₁ represents a circumferential length (μm) of a projected image of the particle, and L₀ represents a circumferential length (μm) of a true circle having an area equal to that of the projected image of the particle.

6. The toner according to claim 5, which further comprising first hydrophobic inorganic fine particle having a mean particle size of 7 to 50 nm,
wherein the monodisperse spherical silica has a work function of less than 5.1 eV and a particle size of 260 to 320 nm,
wherein the amorphous fine particle comprises second hydrophobic inorganic fine particle having the same polarity as the toner mother particle, a volume mean particle size of 0.1 times or less that of the toner mother particle, and a work function larger than that of the monodisperse spherical silica,
wherein the metal soap has a work function of 5.25 to 5.7 eV,
wherein the toner is a non-magnetic single-component negative-charged toner.

7. The toner according to claim 6, which further comprising a titanium oxide of which surface is hydrophobilized,
wherein the second inorganic fine particle has a primary particle size distribution of 200 to 750 nm.

8. The toner according to claim 5,
wherein the toner mother particle is obtained by a polymerization method or a dissolution suspension method.

9. A developing device comprising the toner according to claim 1.
